(19) United States
(12) Patent Application Publication
(10) Pub. No.: US 2019/0283135 A1
(43) Pub. Date: Sep. 19, 2019

(54) NANO/MICRO SCALE POROUS STRUCTURED ALLOYS USING SELECTIVE ALLOYING PROCESS BASED ON ELEMENTAL POWDERS

(71) Applicant: BOARD OF REGENTS, UNIVERSITY OF TEXAS SYSTEM, Austin, TX (US)

(72) Inventors: Yingbin Hu, Edinburg, TX (US); Jianzhi Li, Edinburg, TX (US)

(21) Appl. No.: 16/319,079

(22) PCT Filed: Jul. 18, 2017
(86) PCT No.: PCT/US17/42619

§ 371 Date: Jan. 18, 2019

Related U.S. Application Data
(60) Provisional application No. 62/363,528, filed on Jul. 18, 2016.

(51) Int. Cl. B22F 3/105; B22F 3/11; C22C 14/00

(52) U.S. Cl. CPC B22F 3/1055; B22F 3/11; B33Y 10/00; B22F 2301/205; B22F 2003/1056; C22C 14/00

(57) ABSTRACT

A method of forming titanium boron alloys includes forming a mixture of elemental titanium with elemental boron and heating the mixture with a laser, wherein a power level of the laser is set such that reaction of the elemental titanium with the elemental boron to form a titanium-boron alloy is initiated and self-sustaining.

### BACKGROUND OF THE INVENTION

### 1 Field of the Invention

The invention generally relates to porous metal alloys formed by laser melting processes.

### 2. Description of the Relevant Art

Due to their high tensile strength to density ratio, excellent corrosion resistance and good biocompatibility, titanium (Ti) and its alloys are widely used in astronautic, biomedical and auto industries. Boron-titanium alloys (e.g., boride titanium (TiBw)) exhibits excellent corrosion resistance, hardness and electrical conductivity. Table 1 shows the comparison of properties between Ti and the titanium-boron alloys TiB and TiB₂.

TABLE 1
Properties of Ti, TiB, and TiB₂

| Property | Ti | TiB | TiB₂ |
|---|---|---|---|
| Density (g/cm³) | 4.57 | 4.56 | 4.52 |
| Elastic modulus (GPa) | 110 | 371 | 540 |
| Coeff. Of thermal exp. at (25° C.) | 8.6 × 10⁻⁶ | 7.15 × 10⁻⁶ | 6.2 × 10⁻⁶ |
| Vickers hardness (kg/mm²) | 150 | 1,800 | 2,200 |
| Melting/decomposition temp. | 1,668 | 2,200 | 2,970 |
| (° C.) | | | |

Conventional cast metallurgy approach and powder metallurgy technique can be used to produce titanium-boron alloys. By adding boron powder into a titanium sample, which is melted in a small arc furnace under an inert gas atmosphere, produces Ti-B alloys with different elements ratios, such as Ti-0.05B and Ti-0.1B. These studies found that trace additions of boron refined the α-grain size in CP titanium, which significantly affected the microstructure of titanium. Pre-alloyed powder metallurgy of gas-atomizing Ti-6A1-4V and boron was adopted to produce Ti-B alloy with uniform and fine dispersions of TiB. TiB₂ ceramic disks with density above 98% have been prepared by using the self-propagating high-temperature synthesis/dynamic consolidation (SHS/DC) method. The disks' structural and mechanical properties were adjusted to satisfy military and civilian demands. Spark plasma sintering was used to produce TiB₂ by mixing commercial Ti and amorphous B powders with a molar ratio of Ti:B=1:2 in a swing mill. Then, pulsed high dc current and load was applied to these as-starting powders to create needle-shaped TiB₂.

In addition to these traditional approaches of producing Ti-B alloys mentioned above, laser-aided methods are widely used, especially when it comes to surface hardening of titanium. For a physical property demanding area, such as aerospace applications, discontinuously reinforced titanium-titanium boride (Ti-TiB) composites are used. Laser surface alloying of boron on commercially pure titanium (“CP titanium”) was carried out to create a laser-borided layer on the surface using a continuous-wave CO₂ laser. The formation of the laser-borided surface layer substantially enhances the corrosion resistance, stiffness, wear resistance and microhardness of the CP titanium. Compared to the untreated titanium surface, a dramatic increase of surface hardness from 513 VHN to 1055 VHN was observed. The laser-aided methods are considered better that the conventional diffusion surface treatment method since the latter method involve long processing times and demands a high processing temperature.

### SUMMARY OF THE INVENTION

In an embodiment, a method of forming titanium boron alloys includes: forming a mixture of elemental titanium with elemental boron; and heating the mixture with a laser, wherein a power level of the laser is set such that reaction of the elemental titanium with the elemental boron to form a titanium-boron alloy is initiated and self-sustaining.

In an embodiment, forming the mixture comprises milling elemental titanium powder with elemental boron powder. In some embodiments, the milling process is optimized by selecting a milling time which creates a substantially uniformly distributed mixture. In some embodiments, the milling process is performed for a time of between about 1 hour and about 3 hours.

The molar ratio of elemental titanium to elemental boron in the mixture may be about 1:2, or in some embodiments, the molar ratio of elemental titanium to elemental boron in the mixture is about 4:1.

In an embodiment, the laser is an ytterbium fiber laser. The laser may be operated at a power of between about 30 W and about 140 W at a scanning speed of between about 2 m/sec to about 7 m/sec. 11. The power level of the laser, in some embodiments, is set such that the newly formed titanium-boron alloy is substantially unmelted during heating of the mixture.

In an embodiment, the mixture is disposed on the surface of a metal object. The mixture may be used in a SLM device to form a 3D object.

A titanium boron alloy made by made by the method as set forth above. In some embodiments, the titanium boron alloy has a porosity of up to about 40%.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1A depicts the schematic overview of a selective laser melting (SLM) process;

FIG. 1B depicts a schematic view of a volumetric heat source with a hemispherical shape of the molten pool;

FIG. 1C depicts SEM images of a porous TiB alloy;

FIG. 2 depicts a summary of the factors that affect the SLM process of a mixture of titanium and boron;

FIG. 3 depicts a schematic diagram of a Gaussian-distributed heat source;

FIG. 4 depicts a schematic diagram of an R direction identically distributed laser powder heating process;

FIG. 5 depicts an exemplary the stainless steel solid substrate on which layers of testing powders can be printed;

FIG. 6A depicts a schematic diagram of heating powders on a solid substrate;

FIG. 6B depicts a schematic diagram of heating powders in a cavity;

FIG. 7A depicts an SEM image of commercial pure Ti powder;

FIG. 7B depicts an SEM image of B powder;

FIG. 8A depicts an SEM image of Ti/B powder after 1 hour of milling;

FIG. 8B depicts an SEM image of TUB powder after 2 hours of milling;

FIG. 8C depicts an SEM image of TUB powder after 3 hours of milling;

FIG. 9 depicts the XRD pattern of Ti-B ball-milled for 2 hours;

FIG. 10A depicts the XRD pattern of a TiB₂ porous structure zone;

FIG. 10B depicts an SEM of a TiB₂ porous structure zone;

FIG. 11A depicts a schematic diagram of a series of experiments having different laser power and scanning times;

FIG. 11B depicts the experiment results of the test series depicted in FIG. 11A;

FIG. 12A depicts an SEM of a test substrate having a defined line width;

FIG. 12B depicts the XRD pattern of the line in FIG. 12A;

FIG. 13A depicts a schematic diagram of an alternate series of experiments having different laser power and scanning times;

FIG. 13B depicts the experiment results of the test series depicted in FIG. 13A;

FIG. 13C depicts an XRD pattern of reacted material (molar ratio: 1: x=4: 1);

FIG. 14A depicts an SEM image of sample 4, defined in FIG. 13A;

FIG. 14B depicts an SEM image of sample 8, defined in FIG. 13A;

FIG. 14C depicts an SEM image of sample 12, defined in FIG. 13A;

FIG. 14D depicts an SEM image of sample 16, defined in FIG. 13A;

FIG. 14E depicts an SEM image of sample 15, defined in FIG. 13A;

FIG. 15 depicts an SEM image of sample 12, as defined in FIG. 13A;

FIG. 16A depicts an image illustrating the rough surfaces of the printed parts except sample 4 and sample 16, as defined in FIG. 13A;

FIG. 16B depicts an image illustrating cracks and gaps between different printed parts, as defined in FIG. 13A

FIG. 17A depicts an SEM showing the microstructure of the top surface of sample 1, as defined in FIG. 13A;

FIG. 17B depicts an SEM showing the microstructure of the top surface of sample 2, as defined in FIG. 13A;

FIG. 17C depicts an SEM showing the microstructure of the top surface of sample 3, as defined in FIG. 13A;

FIG. 17D depicts an SEM showing the microstructure of the top surface of sample 4, as defined in FIG. 13A;

FIG. 18A depicts an SEM image of pure Ti powder;

FIG. 18B depicts an SEM image of pure B powder;

FIG. 19A depicts a schematic diagram of an alternate series of experiments having different laser power and scanning times, with powder disposed on a steel substrate;

FIG. 19B depicts an image of blocks formed by laser heating of Ti B power mixtures;

FIG. 20A depicts an SEM image of a mixture of Ti and B particles after 1 hour of milling;

FIG. 20B depict an SEM image of a mixture of Ti and B particles after 2 hours of milling;

FIG. 20C depict an SEM image of a mixture of Ti and B particles after 3 hours of milling;

FIG. 20D depict an SEM image of a mixture of Ti and B particles after 4 hours of milling;

FIG. 20E depict an SEM image of a mixture of Ti and B particles after 5 hours of milling;

FIG. 20F depict an SEM image of a mixture of Ti and B particles after 6 hours of milling;

FIG. 21A depicts an XRD pattern of the starting B powder;

FIG. 21B depicts an XRD pattern of Ti;

FIG. 21C depicts XRD patterns of a TUB powder mixture ball-milled for different times;

FIG. 22 depicts a comparison of the XRD patterns of the SLM-processed TUB parts using various processing parameters, obtained over a wide range of 2θ;

FIG. 23A depicts optical microscope images showing surface morphologies of SLM-processed Ti-B parts at 30 W, 5 m/s;

FIG. 23B depicts optical microscope images showing surface morphologies of SLM-processed Ti-B parts at 60 W, 4 m/s;

FIG. 23C depicts optical microscope images showing surface morphologies of SLM-processed Ti-B parts at 90 W, 3 m/s;

FIG. 23D depicts depicts optical microscope images showing surface morphologies of SLM-processed Ti-B parts at 120 W, 2 m/s;

FIG. 24A depicts an SEM image showing alloy characteristics of SLM-processed Ti-B parts at 30 W, 5 m/s;

FIG. 24B depicts an SEM image showing alloy characteristics of SLM-processed Ti-B parts at 60 W, 4 m/s;

FIG. 24C depicts an SEM image showing alloy characteristics of SLM-processed Ti-B parts at 90 W, 3 m/s; and

FIG. 24A depicts an SEM image showing alloy characteristics of SLM-processed Ti-B parts at 120 W, 2 m/s.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

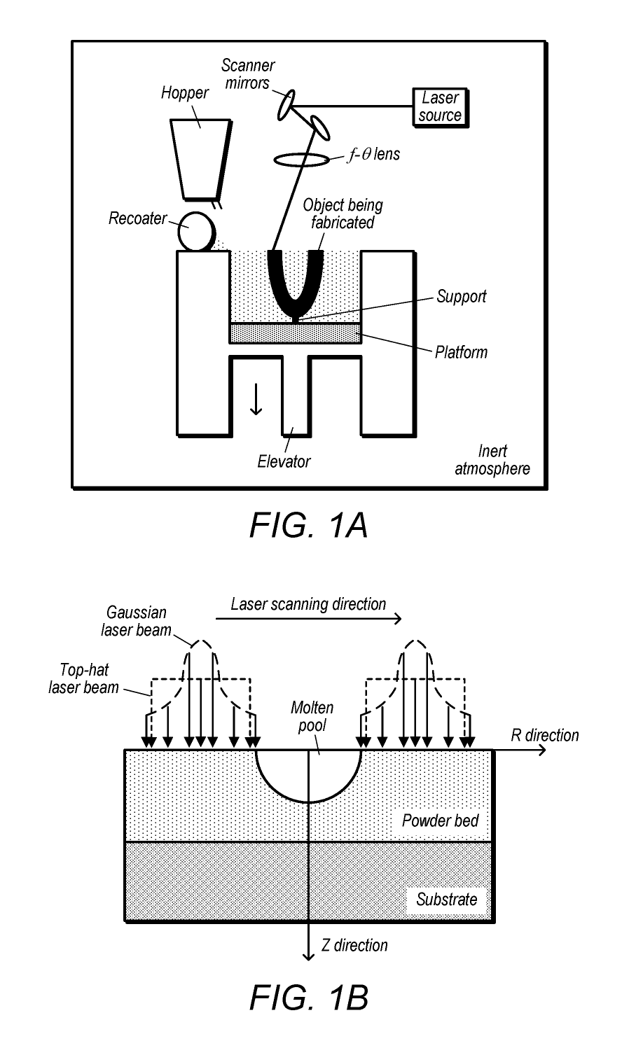

FIG. 1A shows the schematic overview of a selective laser melting (SLM) process. First, a 3D CAD file created by 3D modeling software with standard STL (solid to layer) format is sliced to create a 2-dimensional (2D) profile for each layer. This sliced file prepared by the specific software can also define supports, processing parameters to the corresponding machine. When the file is uploaded and selected, the machine starts working under a controlled low-oxygen atmosphere. As is shown in FIG. 1A, the dosing metallic powder from the hopper will be distributed evenly by the recoater. Then, a laser beam fuses the selected area of this layer based on the sliced 3D file. After the fusing of this layer, the elevator will drive the whole platform one layer down (Z direction) which gives space for the recoater to distribute another layer of powder.

Layer after layer, the final object is created. The laser irradiation process is carried out under an inert atmosphere to avoid oxidation of the powder. Once complete, the object will be removed by chopping down the support underneath and the powder left can be recycled after sieving. The scanning mirrors shown in FIG. 1A can direct the laser beam in X and Y directions.

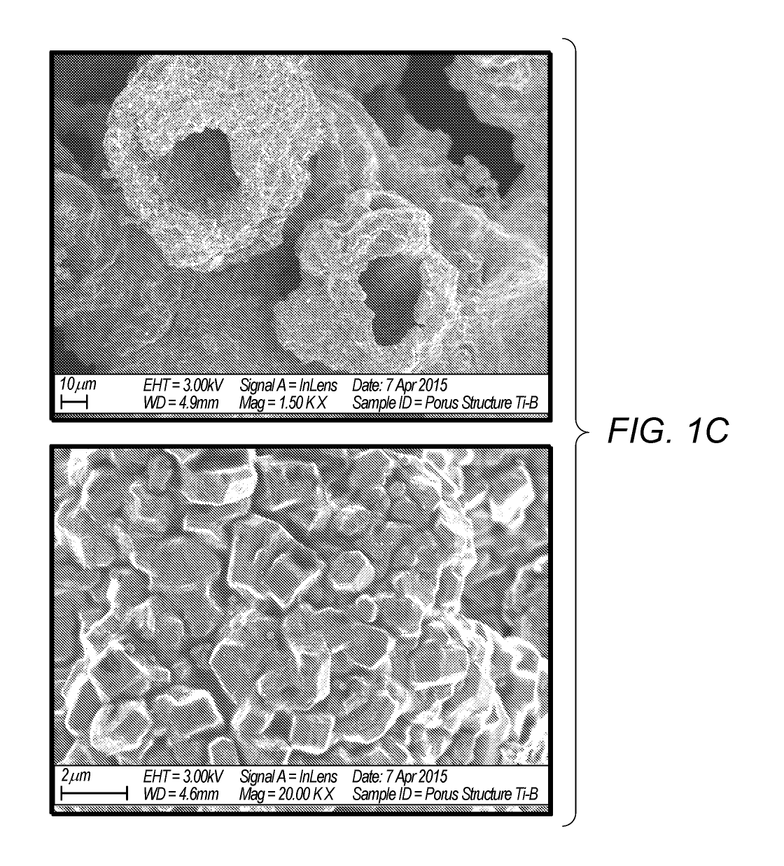

The SLM process of the mixture of titanium and boron has many affecting factors some of which are unexpected or uncontrollable. As is shown in FIG. 2, these factors are roughly categorized as: laser related, material related, reaction related, and other factors. For the laser related factors, laser power and scanning speed are the two major parameters that can be controlled by design. Different values can also be assigned to change the focus diameter, scanning strategy, and hatch distance. Laser wavelength and beam profile are the inherent attributes which cannot be changed.

For the material related factors, different shapes, sizes, and molar ratios of titanium and boron display various physical and chemical properties, such as porosity, flowability, distribution, absorption of laser energy. The platform materials may be stainless steel, aluminum, titanium, ceramics, and so on. Different materials have different thermal properties (e.g. heat conductivity) which may significantly affect the SLM process. In addition, the existence of the unwanted elements can also complicate the laser alloying procedures.

When it comes to the reaction related factors, the temperature-dependent properties of the powder system has to be considered and investigated to understand their impact to the process.

For example, the molar heat capacity of titanium and boron increases with the increasing of temperature. The heat conductivity and laser energy absorption rate vary with different temperatures. To control the reaction between titanium and boron, the reaction trigger temperature is a critical temperature that needs analyzing. Energy dissipation while reaction is almost an unmeasurable factor which depends on not only the type of reaction, but also the surrounding environment.

Besides the factors mentioned above, there are other factors that can influence the formation of titanium boron alloys. The platform temperature is adjustable which can be raised up to 170° C. The existence of oxygen is difficult to avoid while preparing the starting powder mixture and during the laser processing of the powder. Since oxygen can reaction with titanium, it becomes critial to manage the amount of oxygen present. If multiples lines or multiple layers need printing, the former lines or layers will affect the latter ones due to the former ones' residual heat and different surface morphologies. Additionally, the original environment temperature may also affect the process.

In term of the resulting alloy and the micro structure, the invention utilized discrepant melting point of elemental Titanium and Boron powder and the resulting alloys of the two to create porous structured material with controllable size, shape and distribution by varying powder size, molar ration, process rate and process conditions. This principle can be used on other similar material systems. The fundamental concept of creating porous structure in this manner was that, due to the higher melting point of the resulting alloy, a boundary is formulated which would in turn regulate further bonding of the melted elemental powders, the surface tension of the molten pool further facilitated on creation of the pores observed in FIG. 1C. In this regard, this invention can help better control the laser alloying process since pores are generally not desired, or help create nano/micro structures and micro pores with controllable pore size, shape and orientation if it is desired in many applications ranging from coating, lubrication, medical device fabrication, solar panel, super capacitor, protective armor, and energy storage.

Different laser energy input, which can be controlled by adjusting SLM process parameters, will arouse several important physical and chemical phenomena between the titanium and boron powder system, including the melting and evaporating of titanium, boron and their alloys, reactions between titanium, boron and their alloys. In turn, the energy generated from the reaction will also affect the alloying process.

For a SLM machine, laser is the most important heat source. The heatable substrate support can also be another heat source. And as mentioned before, the reactions between titanium and boron can release a huge amount of energy which can also be a heat source if the reactions are triggered. The energy that can be utilized by the titanium and boron system is descripted as follows:

Eᵢₙ−Eₒᵤₜ=E_{system} (1)

Here, Eᵢₙ designates the total energy generated from the process, including laser energy and the energy released from the reaction; Eₒᵤₜ designates the energy escaped out of the system, such as the reflection of laser energy, the heat irradiation to the surrounding area and so on; E_{system} designates the effective energy that is actually absorbed by the powder system.
Equation (1) can be rewritten as:

Eₗₐₛₑᵣ+Eᵣ−E_{laser_reflection}−E_{r_dissipation}=E_{system} (2)

E_{laser_absorption}+E_{r_absorption}=E_{system} (3)

Where, E_{laser_absorption}=AEₗₐₛₑᵣ, A is the absorption coefficient of opaque metal surface of the powder bed. It can be concluded that the combination of the absorption of laser energy (E_{laser_absorption}) and the absorption of the energy from the reaction (E_{r_absorption}) is the total energy that can be used by the system.

### Utilizable Energy

Instead of top-surface heat source, the volumetric heat source with hemispherical shape of the molten pool, as is shown in FIG. 1B, was adopted in this investigation. The Gaussian laser beam was simplified as a top-hat laser beam with collimated incident beam penetrating into the powder along the Z direction. With this simplification, the energy generated from the laser beam heat source can be expressed as:

Eₗₐₛₑᵣ=P * d/v

where, P is the laser power; d is the focus diameter of the laser beam; v is the laser scanning speed.
The absorption coefficient of laser beam energy of mixed powders can be defined as:

Aₗₐₛₑᵣ=A_{laser_1}γ₁+A_{laser_2}γ₂
where, A_{laser_1} and γᵢ (where i=1,2) represent the absorption and the volume fraction of powder i, respectively.

By heating up the mixture pure elemental powders of titanium and boron, the following chemical reactions can take place based on their binary system:

Tᵢ+2B→TᵢB₂ ΔG(R, 1000K)=−308 kj/mol (4)

Tᵢ+TᵢB₂→2TᵢB ΔG(R, 10000K)=−6.3 kj/mol (5)

Tᵢ+B→TᵢB ΔG(R, 10000K)=−157 kj/mol (6)
The negative values of ΔG (the Gibb free energy), calculated using the thermodynamic data, of the reactions above indicate that they are exothermic reactions. It can be concluded that the formation of TiB₂ of Equation (4) is the most negative reaction. However, as long as the boron concentration in the reaction zone is less than 18 mass %, the further reaction between Ti and TiB₂ can take place because of the small negative ΔG value (Equation (5)). The energy generated from the exothermic reaction heat source could be expressed as:

E_{reaction}=n_{Ti}* |ΔG| 1:x≤1:2; E_{reaction}=n_{B}* |ΔG| 1:x≥1:1
where, n_{Ti}n is the amount of substance of Ti; n_{B} is the amount of substance of B; ΔG is the absolute value of the Gibb free energy.

Suppose that the molar ratio between Ti and B was 1: x, then, the amount of Ti within the hemispherical shape of molten pool could be expressed as:

$${n}_{Ti} = \frac{π {d}^{3}}{12} * \frac{{ρ}_{Ti} {ρ}_{B}}{( {ρ}_{B} {M}_{Ti} + x {ρ}_{Ti} {M}_{B} )} * ( 1 - ɛ )$$

where, ρ_{Ti} and ρ_{B} are the densities of Ti and B, respectively; M_{Ti} and M_{B} are the molar masses of Ti and B, respectively; ε is the porosity of the powder bed.
Therefore, the utilizable energy per mole could be expressed as:

$$\begin{matrix}\frac{{E}_{utilizable}}{{n}_{Ti}} = \frac{{A}_{laser} + {E}_{laser} + {A}_{reaction} * {E}_{reaction}}{{n}_{Ti}} \\ = \frac{12 P ( {ρ}_{B} {M}_{Ti} + x {ρ}_{Ti} {M}_{B} ) ( {A}_{Ti} {γ}_{Ti} + {A}_{B} {γ}_{B} )}{π {d}^{2} v {ρ}_{Ti} {ρ}_{B} ( 1 - ɛ )} + \\ \frac{{A}_{reaction} * {E}_{reaction}}{{n}_{Ti}}\end{matrix}$$

Since the elemental titanium and boron can form different compounds, such as TiB, Ti₃B₄, TiB₂ and so on, several models have been developed based on different molar ratios between titanium and boron.

$$\{ \begin{matrix}{T}_{i} : B = 1 : x \\ {T}_{i} + 2 B \to {T}_{i} {B}_{2} , Δ G ( {T}_{i} {B}_{2} ) 1 : x \leq 1 : 2 \\ {T}_{i} + B \to {T}_{i} B , Δ G ( {T}_{i} B ) 1 : x \geq 1 : 1 \\ {T}_{i} + xB \to ( x - 1 ) {T}_{i} {B}_{2} + ( 2 - x ) {T}_{i} B , ( x - 1 ) Δ G ( {T}_{i} {B}_{2} ) + ( 2 - x ) Δ G ( {T}_{i} B ) 1 : 2 < 1 : x < 1 : 1\end{matrix} \}$$

Molar ratio of Ti:B≤1:2

The first case is when the boron is excessive. To develop a general model, it is assumed that the energy that can be used by the powder system is high enough to allow all the physical and chemical phenomena to happen.

E_{system}=n_{T}_{ᵢ}∫_{T}_{ₒ}^{T}^{_{R}}[cₚ(Tᵢ)+2cₚ(B)]dT+(n_{B}−2n_{T}_{ᵢ})[∫_{T}_{ₒ}^{T}^{_{F}}cₚ(B)dT+Lₗ(B)+Lᵥ(B)]+n_{T}_{ᵢ}_{B}_{₂}[∫_{T}_{_{R}}^{T}^{_{F}}cₚ(TᵢB₂)dT+Lₗ(TᵢB₂)+Lᵥ(TᵢB₂)] (7)
Here, n_{T}_{ᵢ}, n_{B}, and n_{T}_{ᵢ}_{B}_{₂} denote amount of substance of titanium, boron, and titanium diboride, respectively; cₚ(Tᵢ), cₚ (B) and cₚ(TᵢB₂) are the molar heat capacity of titanium, boron, and titanium diboride; Lₗ(B) and Lₗ(TᵢB₂) indicate the latent heat of liquefaction of boron and titanium diboride; Similarly, Lᵥ(B) and Lᵥ(TᵢB₂) designate the latent heat of vaporization of boron and titanium diboride; Tₒ is the original temperature of the powder system; T_{R} denotes the reaction trigger temperature; T_{F} is the final temperature of the powder system.

The reaction trigger temperature T_{R} (around 450° C.) is lower than all the elements' and compounds' melting temperature (Schmidt, Boehling, Burkhardt, and Grin, 2007). ∫_{T}_{ₒ}^{T}^{_{F}}c_{P} (B)dT can be expanded as ∫_{T}_{ₒ}^{T}^{_{R}}c_{P} (B)dT+∫_{T}_{_{R}}^{T}^{_{F}}c_{P} (B)dT. It is known that the molar ratio between titanium and boron is 1: x. If n_{T}_{ᵢ}=n, n_{B}=xn and n_{T}_{ᵢ}_{B}_{₂}=n. So, Equation (7) can be simplified as:

$$\frac{{E}_{system}}{n} = {\int }_{{T}_{o}}^{{T}_{R}} [ {c}_{p} ( {T}_{i} ) + {xc}_{p} ( B ) ] dT + ( x - 2 ) [ {\int }_{{T}_{R}}^{{T}_{F}} {c}_{p} ( B ) dT + {L}_{l} ( B ) + {L}_{v} ( B ) ] + {\int }_{{T}_{R}}^{{T}_{F}} {c}_{p} ( {T}_{i} {B}_{2} ) dT + {L}_{l} ( {T}_{i} {B}_{2} ) + {L}_{v} ( {T}_{i} {B}_{2} ) \qquad ( 8 )$$

### Molar Ratio of Ti:B≥1:1

The over dose of titanium leads to different laser processing and reactions between titanium and boron. Based on Equation (4), the model of this case is described as follows:

E_{system}=n_{T}_{ᵢ}∫_{T}_{ₒ}^{T}^{_{R}}[cₚ(Tᵢ)+cₚ(B)]dT+(n_{T}_{ᵢ}−n_{B})[∫_{T}_{ₒ}^{T}^{_{F}}cₚ(Tᵢ)dT+Lₗ(Tᵢ)+Lᵥ(Tᵢ)]+n_{T}_{ᵢ}_{B}[∫_{T}_{_{R}}^{T}^{_{F}}cₚ(TᵢB)dT+Lₗ(TᵢB)+Lᵥ(TᵢB)] (9)
Here, symbols of Equation (8) share the same meaning of Equation (6) but T_{R}. The T_{R} of Equation (6) denotes the trigger temperature of Equation (3), while the T_{R} of Equation (8) denotes the trigger temperature of Equation (5). In addition, n_{TiB}, cₚ(TiB), Lₗ(TiB), and Lᵥ(TiB) indicate the amount of substance, molar heat capacity latent heat of liquefaction, and latent heat of vaporization of TiB. If n_{Ti}=n, n_{B}=xₙ and n_{TiB2}=xn, Equation (9) can be simplified as:

$$\frac{{E}_{system}}{n} = x {\int }_{{T}_{o}}^{{T}_{R}} {c}_{p} ( B ) dT + {\int }_{{T}_{o}}^{{T}_{R}} {c}_{p} ( {T}_{i} ) dT + ( 1 - x ) [ {\int }_{{T}_{R}}^{{T}_{F}} {c}_{p} ( {T}_{i} ) dT + {L}_{l} ( {T}_{i} ) + {L}_{v} ( {T}_{i} ) ] + x [ {\int }_{{T}_{R}}^{{T}_{F}} {c}_{p} ( {T}_{i} B ) dT + {L}_{l} ( {T}_{i} B ) + {L}_{v} ( {T}_{i} B ) ] \qquad ( 10 )$$

### Molar Ratio of 1:2<Ti:B<1:1

Assume that if the molar ratio of titanium and boron is between the two critical values 1:2 and 1:1, the following reaction will occur:

Tᵢ+xB→(x−1) TᵢB₂+(2−x) TᵢB, (x−1) ΔG(TᵢB₂)+(2−x) ΔG(TᵢB)
Then, the model of this case is:

E_{system}=∫_{T}_{ₒ}^{T}^{_{R}}[n_{T}_{ᵢ}cₚ(Tᵢ)+n_{B}cₚ(B)]dT+n_{T}_{ᵢ}B₂[∫_{T}_{_{R}}^{T}^{_{F}}cₚ(TᵢB₂)dT+Lₗ(TᵢB₂)+Lᵥ(TᵢB₂)]+n_{T}_{ᵢ}_{B}[∫_{T}_{_{R}}^{T}^{_{F}}cₚ(TᵢB)dT+Lₗ(TᵢB)+Lᵥ(TᵢB)] (11)

If n_{Ti}=n, then n_{B}=xn, n_{TiB2}=(x−1)n, n_{TiB}=(2−x)n. Equation (11) can be simplified as:

$$\frac{{E}_{system}}{n} = x {\int }_{{T}_{o}}^{{T}_{R}} [ {c}_{p} ( {T}_{i} ) + {xc}_{p} ( B ) ] dT + ( x - 1 ) [ {\int }_{{T}_{R}}^{{T}_{F}} {c}_{p} ( {T}_{i} {B}_{2} ) dT + {L}_{l} ( {T}_{i} {B}_{2} ) + {L}_{v} ( {T}_{i} {B}_{2} ) ] + ( 2 - x ) [ {\int }_{{T}_{R}}^{{T}_{F}} {c}_{p} ( {T}_{i} B ) dT + {L}_{l} ( {T}_{i} B ) + {L}_{v} ( {T}_{i} B ) ] \qquad ( 12 )$$

However, since the trigger temperature T_{R} of the formation of TiB₂ and TiB is not the same value, the model has to be modified to compensate the difference. At the same time, within this ratio scale, the possibility of the formation of Ti₃B₄ will further complicate this case.

### Volumetric Selective Laser Alloying Zone on the Powder Bed

The volumetric heat source is adopted since the laser energy is deposited in the bulk of the powder bed instead of just on the top surface. The reason is that the laser beam can be reflected several times until it reaches a certain depth.

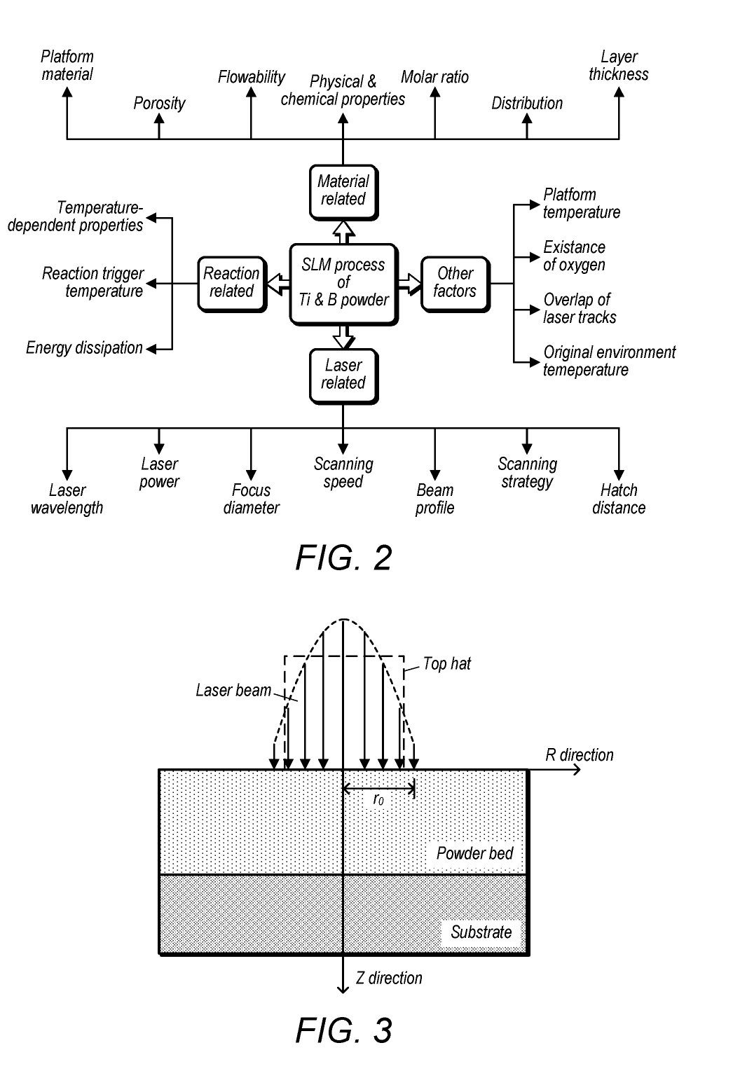

The laser beam may be treated as a heat flux, Q, which is a Gaussian-distributed heat source. The heat flux is in proportion to the laser power, P. It can be described as:

$$Q = \frac{2 PA}{π {r}_{0}^{2}} {e}^{- \frac{2 {r}^{2}}{{r}_{0}^{2}}} \qquad ( 12 )$$

Where r₀ is the radius of the laser beam which is demonstrated in FIG. 3. The r₀ is chosen the value of which is e⁻² times of that of the central laser beam. r is the distance between the point of the powder bed surface and the center point. The real laser beam has a Gaussian distribution profile, while the vicinity of the beam focus is similar to a top-hat profile.

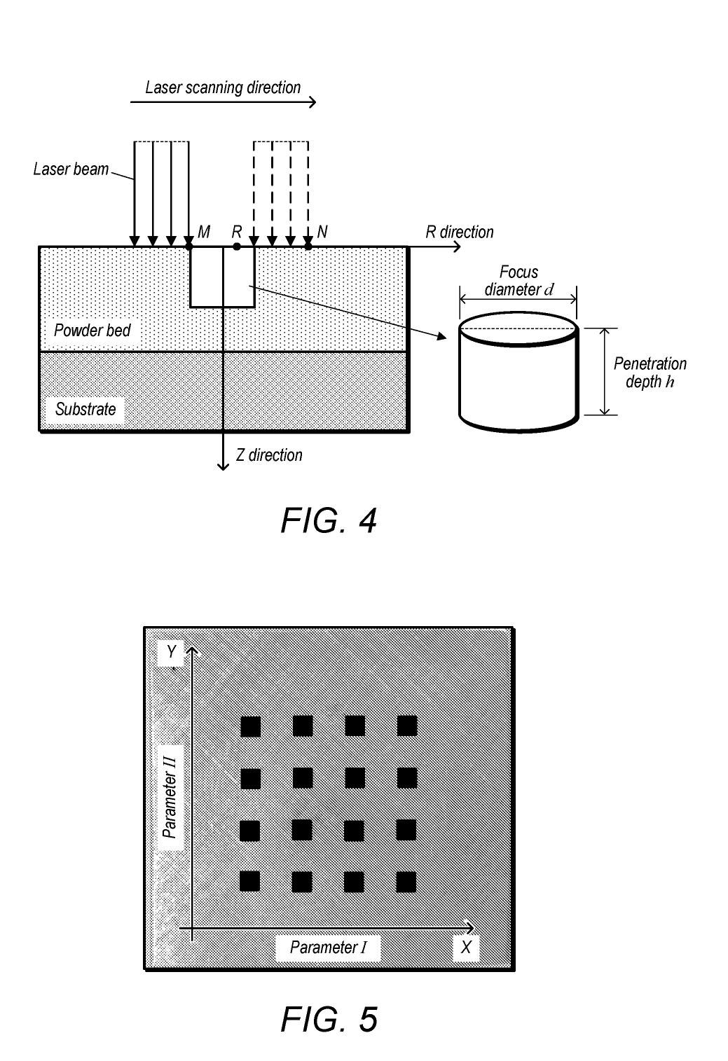

It can be seen from FIG. 4 that instead of Gaussian-distributed laser power, an R direction identically distributed laser powder is adopted to simplify the model. The collimated incident beam penetrates into the powder evenly along the Z direction. Therefore, the volumetric laser alloying zone is a cylinder with the diameter d (the same as laser's focus diameter) and height h (laser penetration depth). Suppose that the laser scanning speed is v, laser scanning from point M to point N with the distance of 2d would take the time of 2d/v. As a point on the yellow surface area R is exposed to the laser beam for a duration of d/v, the whole cylinder is exposed under the laser beam for a duration of d/v, too. Thus, the laser irradiation time of a certain area is d/v. If P is the power of laser with the unit of watts, then, E_{laser-absorption} of Equation (3) can be deducted as:

E_{laser_absorption}=AEₗₐₛₑᵣ=APt=APd/v (13)
where, A denotes the laser absorption coefficient of the powder system with titanium and boron. The absorption of a powder mixture of two components cab be calculated by using the following equation:

A=A₁γ₁+A₂γ₂ (14)
Here, Aᵢ and γᵢ indicate the absorption coefficient and volume fraction of component i, respectively.
Similarly, the reaction absorption energy can be modeled as:

$$\frac{{E}_{r \_ absorption}}{n} = {A}^{′} \vert Δ G \vert \qquad ( 15 )$$

where, A′ denotes the reaction absorption coefficient of the powder bed; |ΔG| is the absolute value of the energy released from the reaction.

Due to the multi-reflection of the laser beam, the laser radiation can penetrate into the powder bed of a certain depth h. Here, we assume that within the height of h, the laser powder is identically distributed, and beyond the height of h, there is no laser energy. The volume of this cylinder is:

$$V = {π ( \frac{d}{2} )}^{2} h \qquad ( 16 )$$

It is known that the molar ratio between titanium and boron is 1:x. Then, the amount of titanium can be calculated as follows:

$$\begin{matrix}{V}_{{T}_{i}} \text{:} {V}_{B} = \frac{{m}_{{T}_{i}}}{{ρ}_{{T}_{i}}} \text{:} \frac{{m}_{B}}{{ρ}_{B}} = \frac{{n}_{{T}_{i}} {M}_{{T}_{i}}}{{ρ}_{{T}_{i}}} \text{:} \frac{{n}_{B} {M}_{B}}{{ρ}_{B}} & ( 17 ) \\ {M}_{{T}_{i}} = {ρ}_{{T}_{i}} \frac{{V}_{{T}_{i}}}{{V}_{{T}_{i}} + {V}_{B}} V ( 1 - ɛ ) & ( 18 )\end{matrix}$$

### Hence,

$$n = {n}_{{T}_{i}} = \frac{{m}_{{T}_{i}}}{{M}_{{T}_{i}}} = \frac{π {d}^{2} h {ρ}_{{T}_{i}} {ρ}_{B} ( 1 - ɛ )}{4 ( {ρ}_{B} {M}_{{T}_{i}} + x {ρ}_{{T}_{i}} {M}_{B} )} \qquad ( 19 )$$

Here, m_{T}_{ᵢ} and m_{B} denote the mass of titanium and boron, respectively; V_{T}_{ᵢ} and V_{B} are the volume; ρ_{T}_{ᵢ} and ρ_{B} denote the density of titanium and boron; M_{T}_{ᵢ} and M_{B} are titanium's and boron's molar mass, respectively; ε designates the porosity of the powder bed.
So,

$$\frac{{E}_{system}}{n} = \frac{{E}_{laser \_ absorption} + {E}_{r \_ absorption}}{n} = \frac{4 ( {ρ}_{B} {M}_{{T}_{i}} + x {ρ}_{{T}_{i}} {M}_{B} ) ( {A}_{{T}_{i}} {γ}_{{T}_{i}} + {A}_{B} {γ}_{B} ) Pd}{v π {d}^{2} h {ρ}_{{T}_{i}} {ρ}_{B} ( 1 - ɛ )} + {A}^{′} \vert Δ G \vert \qquad ( 20 )$$

### Process Parameters of Selective Laser Alloying of Ti-B System

The variables of the models correspondent to the process parameters of the selective laser alloying process, which can be categorized as laser related, titanium related, boron related, TiB₂ related, TiB related, reaction related and other factors. For the laser related variables, the values are provided from the AM250 machine (RENISHAW) specification. The focus diameter of the laser beam is 70 μm. The maximum laser power of this machine is 200 W and can be adjusted from 0 to 200 W as needed. The maximum scanning speed of the laser is 7 m/s, and can be varied from 0 to 7 m/s. The penetration depth of the laser is the height of reaction area. Taking the fact that the laser power weakens rapidly along the Z direction, 50 μm which is shorter than the real penetration depth is adopted. In addition, 50 μm is also the suggested layer thickness of the machine. The absorption of the titanium powder by using Nd-YAG (λ=1.06 μm) laser is 0.77. Since no absorption data of the boron is available, a constant conservative value of 50% is assumed regardless the volume ratio between titanium and boron.

The molar mass of titanium is 47.87 g/mol, and all the other values are retrieved from industrial databases. Similarly, the molar mass of boron is 10.81 g/mol, and all the other values are retrieved from industrial databases. The values are listed in Table 2. The molar heat capacity of TiB₂ at the temperature of 300 K is 49.91 J/(mol·K). The latent heat of liquefaction of TiB₂ is 100.4 kJ/mol. The molar heat capacity of TiB ranges from 50.06 to 56.07 J/(mol·K) with the increasing of temperature from 700 K to 4000 K. A constant value of 51 J/(mol·K) is adopted as TiB's molar heat capacity. The melting temperature of TiB₂ and TiB are set forth in Table 1.

For the reaction related variables, the values of ΔG(TiB₂) and ΔG(TiB) are under the temperature of 1000 K. The ΔG of Equation (1) and Equation (3) at 298 K are −278 kJ/mol and −161 kJ/mol respectively, which means that the Gibb free energy does not change too much within narrow temperature range from 298 K to 1000 K. Thus, the approximate values of −300 kJ/mol and −160 kJ/mol for Equation (4) and Equation (6) will be adopted.

ΔG(TᵢB₂)=−300 kJ/mol

ΔG(Tᵢ₁B)=−160 kJ/mol

It can be concluded that the formation of TiB₂ of Equation (4) is the most negative reaction. However, as long as the boron concentration in the reaction zone is less than 18 mass %, the further reaction between B and TiB₂ can take place because of the small negative ΔG value (Equation (5)).

When the reaction is on, most of the energy released will escape as light and heat, only a little bit of it can be captured by the surrounded powders. So the value of 10% is assigned to the reaction absorption coefficient. Exothermic reactions have been detected by raising the mixture of elemental titanium and boron powder with the molar ratio of 1:2 to 450° C. So, the trigger temperature of the reaction Tᵢ+2B→TᵢB₂ is 723K. If the molar ratio between titanium and boron is 4:1, the reaction Tᵢ+B→TᵢB takes place as two steps as shown in Equations (4) and (5). The Equation (4) occurs first. Due to the negative ΔG value, Equation (5) will also happen soon afterwards. Thus, the trigger temperature of the reaction Tᵢ+B→TᵢB can also be considered as 723K. Room temperature of 298 K is the original temperature of this system. The porosity of 40% is selected based on the powders shape and compact condition.

It should be noticed that some of the properties are temperature-dependent, such as density, laser absorption coefficient, and molar heat capacity.

TABLE 2

| Categories | Variables | Values |
|---|---|---|
| Laser related | Focus diameter: d (μm) | 70 |
| | Laser power: P (W) | 0-200 |
| | Scanning speed: v (m/s) | <7 |
| | Penetration depth: h (μm) | 50 |
| | Laser absorption coeff.: A | 50% |
| Titanium related | Molar mass: M_{T}_{ᵢ} (g/mol) | 47.87 |
| | Density: ρ_{T}_{ᵢ} (g/cm³) | 4.51 |
| | Molar heat capacity: cₚ(Tᵢ) (J/(mol · K)) | 25.06 |
| | Latent heat of liquefaction: Lₗ(Tᵢ) (kJ/mol) | 14.15 |
| | Latent heat of vaporization: Lᵥ(Tᵢ) (kJ/mol) | 425 |
| | Melting temperature: T_{M}(Tᵢ) (K) | 1941 |
| | Boiling temperature: T_{B}(Tᵢ) (K) | 3560 |
| Boron related | Molar mass: M_{B} (g/mol) | 10.81 |
| | Density: ρ_{B} (g/cm³) | 2.08 |
| | Molar heat capacity: cₚ(B) (J/(mol · K)) | 11.09 |
| | Latent heat of liquefaction: Lₗ(B) (kJ/mol) | 50.2 |
| | Latent heat of vaporization: Lᵥ(B) (kJ/mol) | 508 |
| | Melting temperature: T_{M}(B) (K) | 2349 |
| | Boiling temperature: T_{B}(B) (K) | 4200 |
| TᵢB₂ related | Molar heat capacity: cₚ(TᵢB₂) (J/(mol · K)) | 49.91 |
| | Latent heat of liquefaction: Lₗ(TᵢB₂) (kJ/mol) | 100.4 |
| | Latent heat of vaporization: Lᵥ(TᵢB₂) | / |
| | (kJ/mol) | |
| | Melting temperature: T_{M}(TᵢB₂) (K) | 3243 |
| | Boiling temperature: T_{B}(TᵢB₂) (K) | / |
| TᵢB related | Molar heat capacity: cₚ(TᵢB) (J/(mol · K)) | 51 |
| | Latent heat of liquefaction: Lₗ(TᵢB) (kJ/mol) | |
| | Latent heat of vaporization: Lᵥ(TᵢB) (kJ/mol) | |
| | Melting temperature: T_{M}(TᵢB) (K) | 2473 |
| | Boiling temperature: T_{B}(TᵢB) (K) | |
| Reaction related | Reaction released energy: ΔG(TᵢB₂) (kJ/mol) | −300 |
| | Reaction released energy: ΔG(TᵢB) (kJ/mol) | −160 |
| | Reaction absorption coeff.: A′ | 10% |
| | Reaction trigger temperature: T_{R} (K) | 723 |
| Other | Original temperature (Room temp.) (K) | 298 |
| | Porosity: ε | 40% |

### Experiment Design

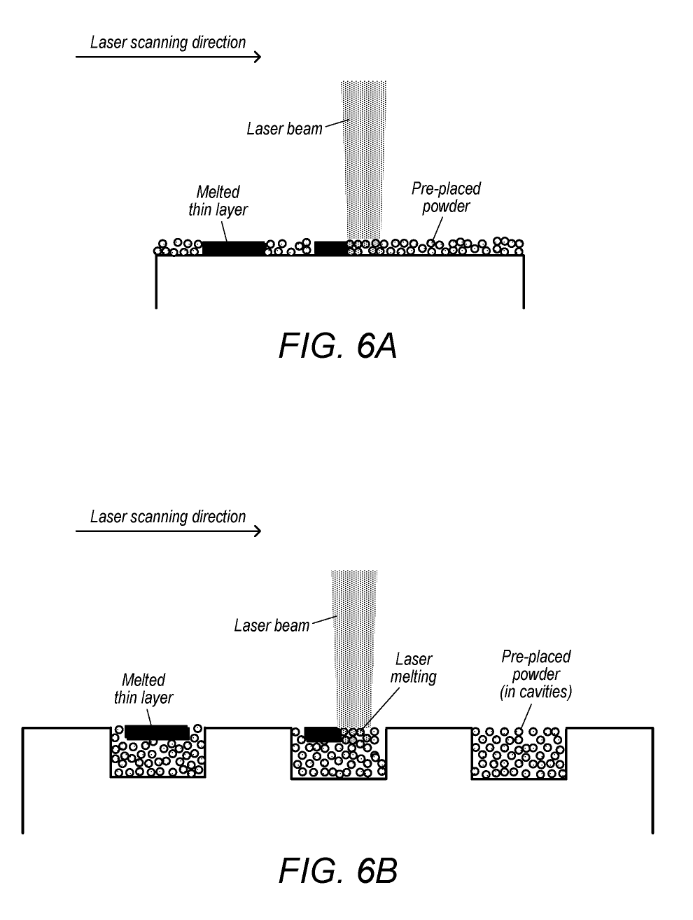

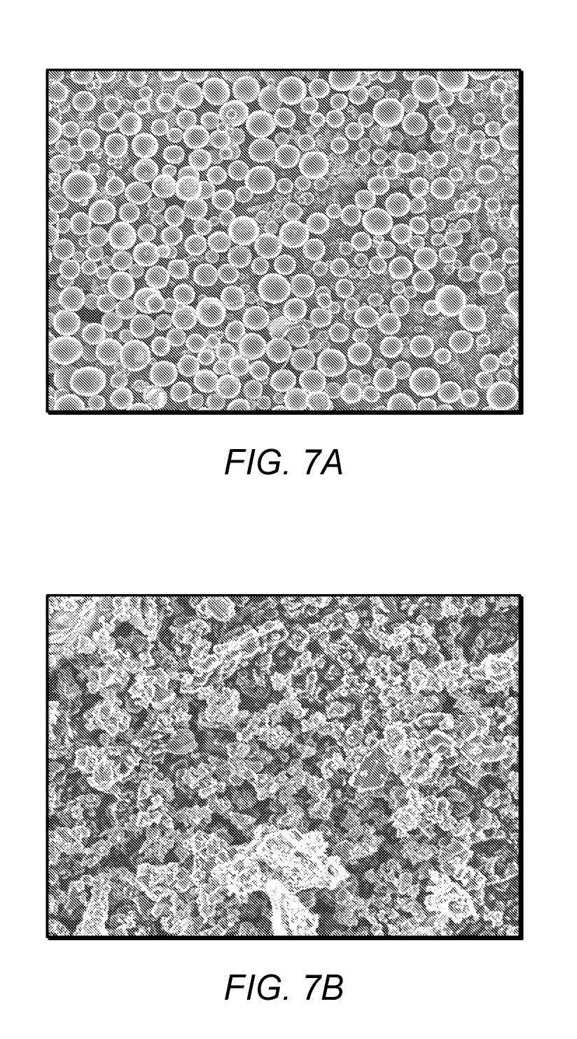

To save time and material, different processing parameters can be tested at the same time by creating test series. In practice, 4 values of Parameter I and Parameter II are assigned along the X and Y directions as is shown in FIG. 5. Thus, 4×4=16 samples can be created at one time for the following analysis. Two types of melting mechanisms are investigated: melting on A solid substrates (stainless steel and ceramics); and melting on the loose powder in cavities (aluminum). The two types of melting mechanisms are depicted in FIGS. 6A and 6B.

FIG. 5 shows the stainless steel solid substrate on which layers of testing powders can be printed. Since iron is also easily melted, the stainless steel solid substrate may affect the printed layers of testing powders by adding iron element, especially when only a few layers are printed. In this case, ceramics solid substrate will be used instead to avoid the effect of stainless steel substrate. For the aluminum substrate with 16 cavities on the top surface, the laser processes the powder on the top layer of the cavities. Since the cavities have relatively deep depth of 0.8 mm, compare to the 50 μm printing layer, the effect of the substrate on the printing process is small enough to be eliminated. As can be seen from FIG. 6A the melted thin layer is attached to the solid substrate. While for FIG. 6B, the melted thin layer on top of the loose powder can be removed easily for post-processing.

### Powder Preparation

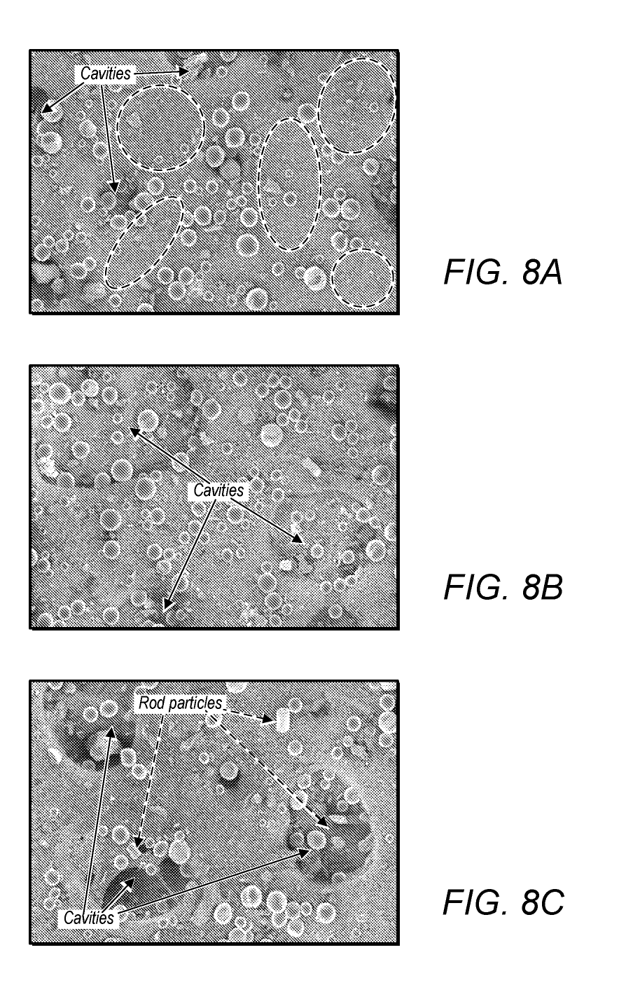

Commercial pure (CP) Ti powder (FIG. 7A) having a spherical shape, supplied by LPW Technology Ltd. (USA), was used for the studies set forth herein. The normal particle size distribution is between 15 to 45 microns. The chemical composition of the CP Ti powder (wt. %) is: Ti (99.495%); Fe (0.2%); O (0.18%); C (0.08%); N (0.03%); and H (0.015%). The boron powder, supplied by the Chemsavers. Inc. (USA), exhibits an irregular shape (FIG. 7B), whose purity is greater than 96%. The boron powder's particle size is less than 5 microns.

The mechanical mixing of the elemental powders (Ti and B) was carried out by using the planetary ball mill PM 200 (Retsch, Germany) under the protective argon atmosphere. Two different molar ratios of Ti:B=1:2 (Ti-31 wt. % B) and Ti:B=4:1 (Ti-5.3 wt. % B) were processed.

Ball (steel balls with diameter of 10 mm) to powder weight ratio of 5:1 was used. To avoid alloy or reaction between Ti and B powders, a relatively low rotation speed of 100 rpm for 1˜3 hours was set for the ball milling process and the machine rests for 10 seconds every 5 minutes.

Phase characterization identification was performed with powder X-ray diffraction (XRD) (Broker D8 Advanced XRD Instrument). The wide range of 2θ=10˜100° with a continuous scan mode was carried out to generate a general information of the diffraction peaks.

Compare the XRD experiment results with the existing substances database of XRD, phase composition can be determined if the experiment diffraction peaks match the corresponding peak positions from the database. The SEM machine enabled the observation of microstructures of the samples with the resolution up to 1 nm. The surface shape morphology and size distribution of the material to be observed can be provided. Energy-dispersive X-ray spectroscopy (EDAX), integrated within the SEM machine, can identify and quantify the elements to be observed.

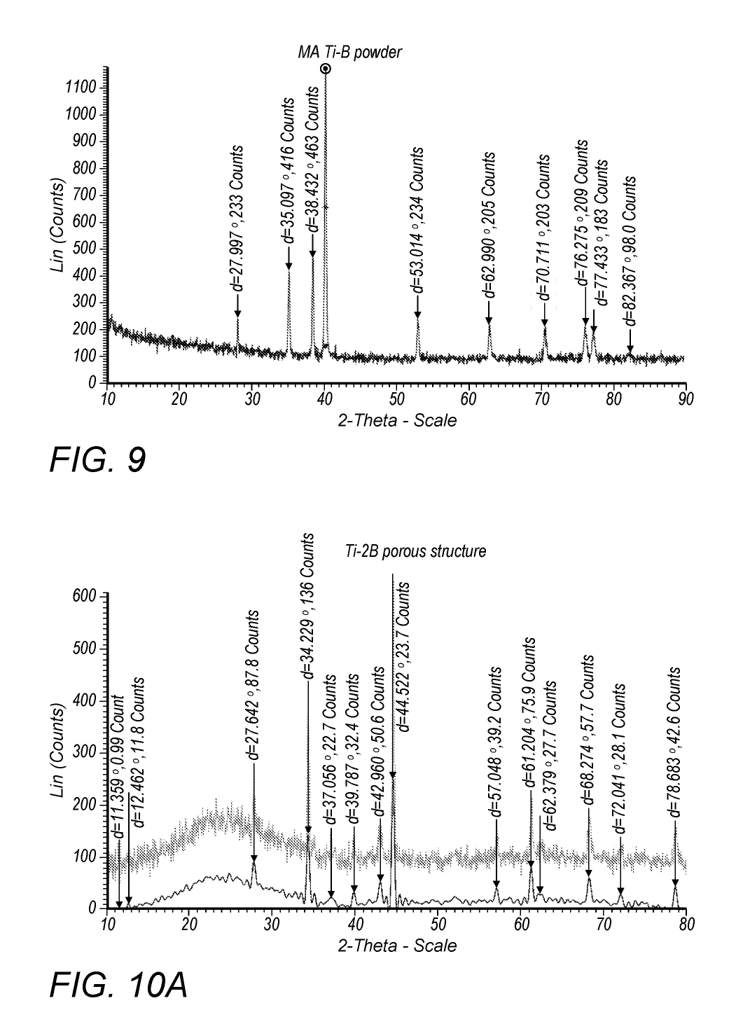

FIGS. 8A-C show the mixing condition and particle-morphologies of the Ti-B powders after different times of milling. During the milling process, spherical titanium particles were distributed among the finer irregular boron powders and some of the titanium powders were formed into rod shape. While, cavities were created due to the loose density of the as-received boron powder as is shown in FIG. 8C.

After the first hour of milling, the titanium particles were not uniformly distributed among the boron matrix (FIG. 8A). The yellow-dash circled area contained very few titanium particles. Compare to the cavities shown in FIG. 8B, the cavities of FIG. 8C were relatively smaller but deeper. For FIG. 8B, the titanium particles were well distributed among the boron matrix, without obvious “blank area” circled by yellow dashed lines as shown in FIG. 8A. In addition, the shallow cavities which slightly affected the selective laser alloying process of FIG. 8B were acceptable. By increasing the milling time to 3 h (FIG. 8C), the cavities became deeper. The titanium particles were preferentially dispersed into these cavity areas. Because of long time of milling, the collisions between balls and powders flattened the titanium particles into rod shape (FIG. 8C). According to the above, 2 h ball milling of the Ti-B was selected as the optimizing process parameter of the starting powder for SLM due to the well-distributed titanium powder among boron matrix and the relatively shallow cavities. In addition, the titanium particles maintained spherical shape.

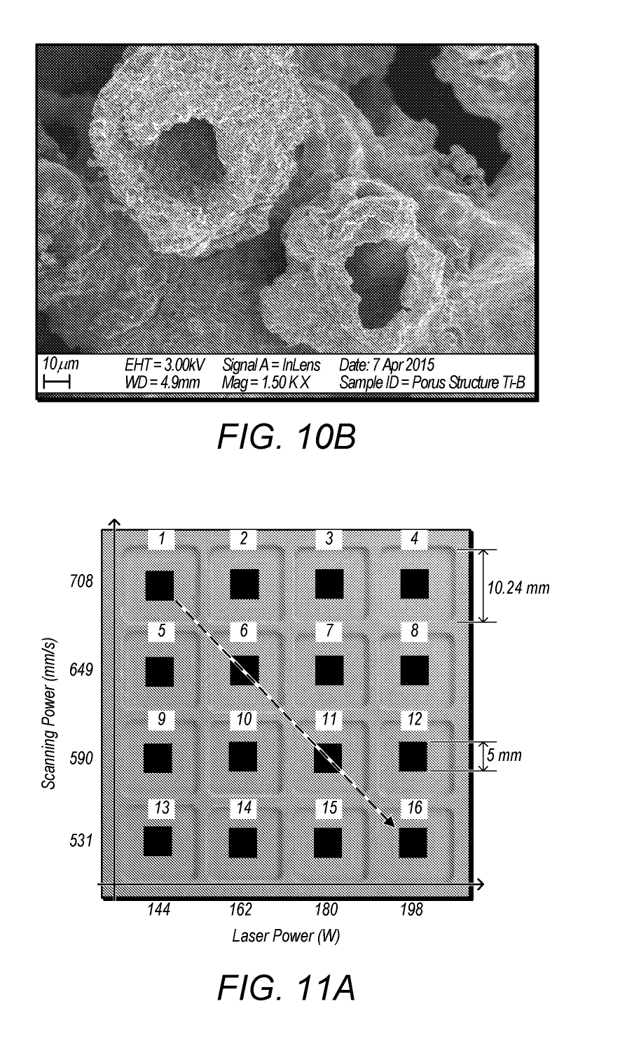

FIG. 9 shows the XRD pattern of Ti-B ball-milled for 2 h. It can be seen that there are only elemental titanium and boron after the milling. No diffraction peaks of TiB or TiB₂ were observed which satisfied our experiment purpose. In another word, mechanical mixing, instead of mechanical alloy, of the titanium and boron powders were created for the following SLM processes.

### Verification Experiments of the Ti:B=1:2 Model

When the molar ratio between titanium and boron is 1:2, Equation (8) can be rewritten as:

$$\frac{{E}_{system}}{n} = {\int }_{{T}_{0}}^{{T}_{R}} [ {c}_{p} ( {T}_{i} ) + 2 {c}_{p} ( B ) ] dT + {\int }_{{T}_{R}}^{{T}_{F}} {c}_{p} ( {T}_{i} {B}_{2} ) + {L}_{1} ( {T}_{i} {B}_{2} ) + {L}_{v} ( {T}_{i} {B}_{2} ) \qquad ( 21 )$$

This is a general equation with the assumption that the energy input on the left hand side is high enough to cause all the changes on the right hand side. However, sometimes the changes on the right hand side may only partially happen. To better understand it, several intervals are created based on energy input.

E₁=∫_{T}_{ₒ}^{T}^{_{R}}[cₚ(Tᵢ)+2cₚ(B)]dT=20.08 kJ/mol: Energy required to trigger the reaction.

E₂=∫_{T}_{ₒ}^{T}_{R}[cₚ(Tᵢ)+2cₚ(B)]dT+∫_{T}_{_{R}}^{T}^{_{M}}^{(T}^{ᵢ}^{B}^{₂}^{) c}ₚ(Tₚ(TᵢB₂)d=145.85 kJ/mol:Energy required to raise the whole system to the melting temperature of TiB₂, without melting.

E₃=∫_{T}_{ₒ}^{T}^{_{R}}[cₚ(Tᵢ)+2cₚ(B)]dT+∫_{T}_{_{R}}^{T}^{_{M}}^{(T}^{ᵢ}^{B}^{₂}⁾cₚ(TᵢB₂)dT+Lₗ(TᵢB₂)=246.25 kJ/mol:
Energy required to melt TiB₂.

Since there is no enough vaporization information of the compound of TiB₂, the vaporization energy cannot be calculated.

The molar ratio is 1:x=1:2:

$$n = {n}_{{T}_{i}} = \frac{π {d}^{2} h {ρ}_{{T}_{i}} {ρ}_{B} ( 1 - ɛ )}{4 ( {ρ}_{B} {M}_{{T}_{i}} + 2 {ρ}_{{T}_{i}} {M}_{B} )} = 5.5 \times {10}^{- 9} mol \qquad ( 22 )$$

The laser parameters of this experiment are: laser power 30 W; scanning speed 7 m/s. This energy input triggered the reaction of titanium and boron, and the reaction spread to the surrounding area where a dramatic burning phenomenon is observed. Based on the laser parameter,

$$\frac{{E}_{laser \_ absorption}}{n} = \frac{APd / v}{n} = 27.27 kJ \text{/} mol > 20.08 kJ \text{/} mol = {E}_{1}$$

This means that the absorbed laser energy can trigger the reaction between titanium and boron which is the case of the experiment. For the surrounding area where there is no laser energy input:

$$\frac{{E}_{reaction \_ absorption}}{n} = {A}^{′} \vert Δ G ( {T}_{i} {B}_{2} ) \vert = 30 kJ \text{/} mol > 20.08 kJ \text{/} mol = {E}_{1}$$

The absorbed reaction energy can continue triggering the reaction, which means that the titanium and boron reaction is self-sustainable of this molar ratio under this certain condition. This is in good agreement with the burning phenomenon of the experiment.
For the area where there was laser energy input and also the energy obtained from the reaction.

$$\frac{{E}_{system}}{n} = \frac{{E}_{laser \_ absorption} + {E}_{reaction \_ absorption}}{n} = 57.27 \frac{kJ}{mol} < 145.85 \frac{kJ}{mol} = {E}_{2}$$

This indicates that the energy of the laser irradiation zone cannot melt the newly generated TiB₂.

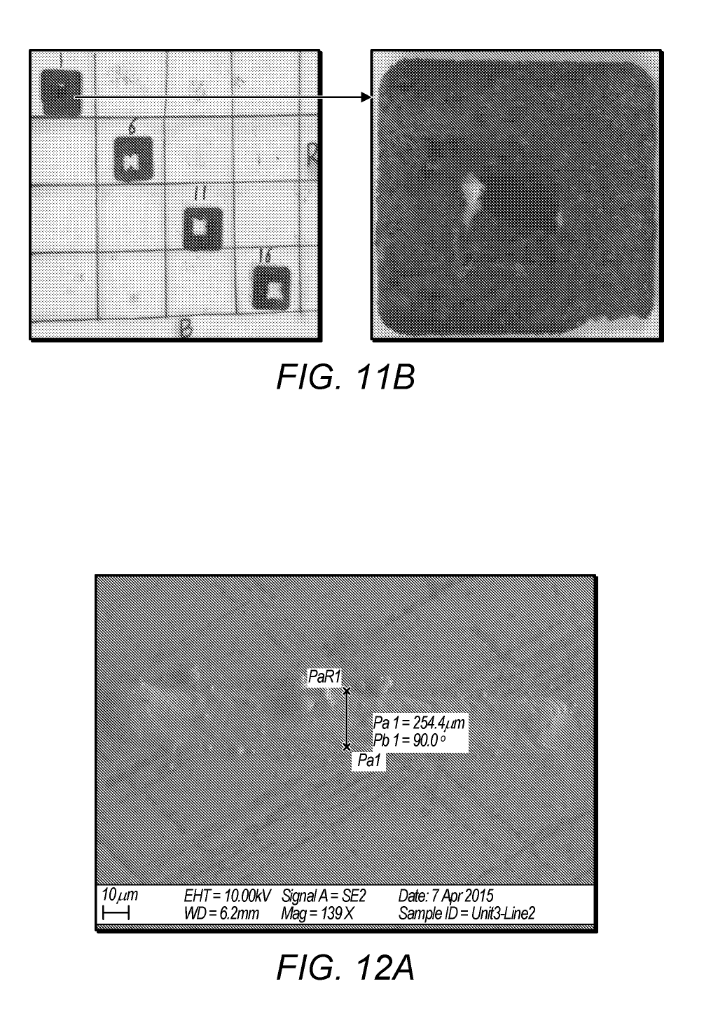

FIG. 10A shows the XRD pattern of the porous structure zone, which proved the formation of TiB₂. The porous structure is shown in FIG. 10B. The pores are in spherical shape with an average diameter of 20 μm which is in the same order of magnitudes of titanium (spherical, 15˜45 μm). So, it can be concluded that the spherical pores are where the initial titanium powders locate. Since the energy input of the irradiation zone is not high enough to melt TiB₂, the randomly distributed TiB₂ bulks could not collapse or flowed into a solid and dense part.

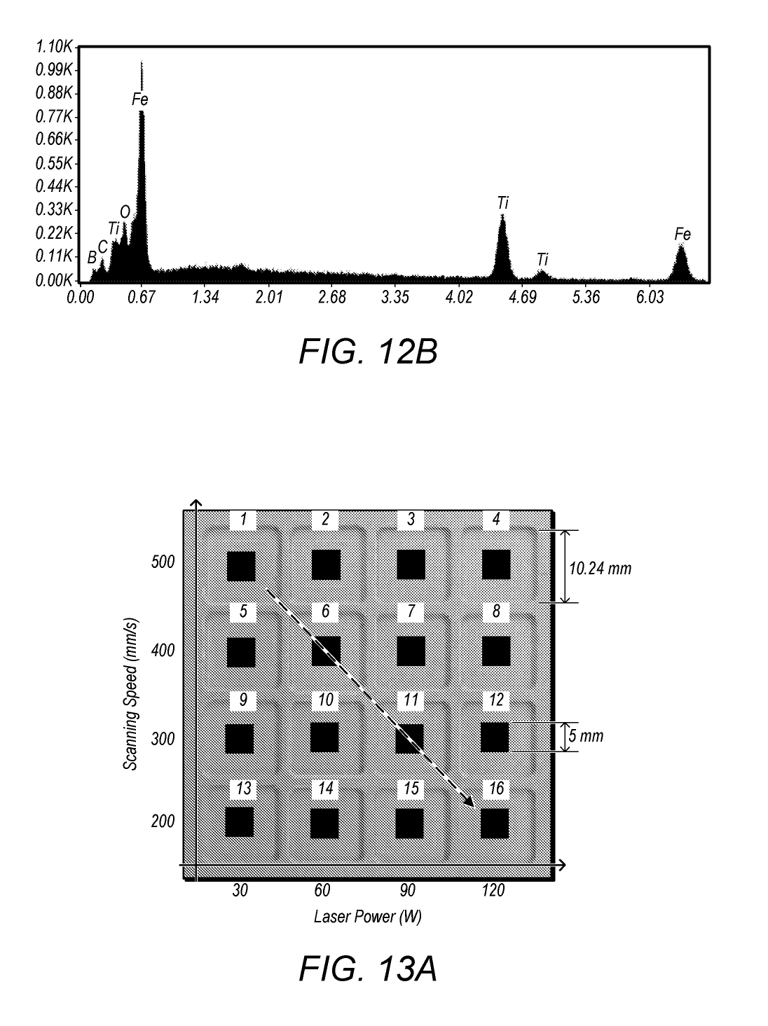

To at least melt TiB₂, high energy input by defining the test series was carried out. The laser power and scanning speed are two controlled parameters as is shown in FIG. 11A. From the left to the right column, the values of laser power increase from 144 to 180 W. From the top to the bottom row, the values of scanning speed decrease from 708 to 531 mm/s. So it can be concluded that laser energy inputs increase from the left top corner to the right bottom corner. The black squares inside each cavity are the laser irradiation zones.

The calculated E_{system}/n values are between 1300 kJ/mol and 2400 kJ/mol. These values are extremely higher than the energy required (246.25 kJ/mol) to melt TiB₂. However, the laser absorption coefficient of TiB₂ is different from that of the mixture of titanium and boron. The molar heat capacity of TiB₂ at elevated temperature is different than that of TiB₂ at low temperature. All these factors make it hard to get the exact value of energy to evaporate TiB₂.

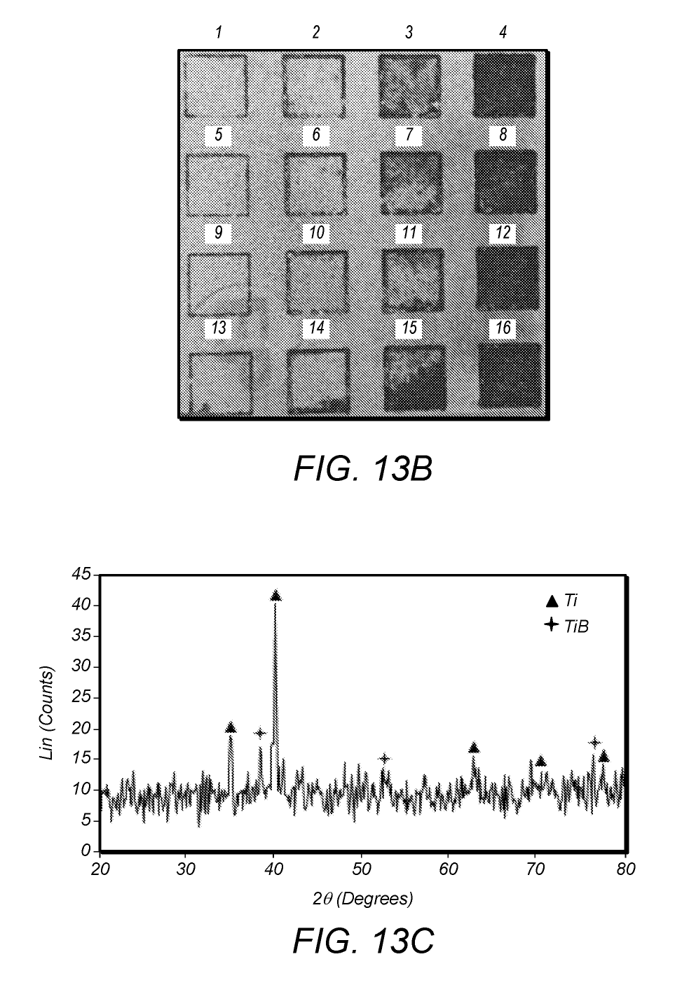

FIG. 11B shows the experiment results of the test series. The hollow areas in the center (laser irradiation zone) of sample 6, 11, and 16 indicate the vaporization of TiB₂. For sample 1, there is still material in the center of the irradiation zone. As analyzed above, even the lowest energy input can melt the newly formed TiB₂. This is the reason why the height of the center square of sample 1 is lower than that of the surrounding area. The big chunk with the size of 100.5 μm shown in FIG. 12 indicates the melt of the formed TiB₂. Compared to the microstructure of FIG. 10B, there is no obvious hollow structure of FIG. 12 which is also a proof that melt occurred with the high laser energy input.

Verification experiments of the Ti:B=4:1 model

If the molar ratio between titanium and boron is 4:1 (1:1/4), Equation (10) can be rewritten as:

$$\frac{{E}_{system}}{n} = \frac{1}{4} {\int }_{{T}_{o}}^{{T}_{R}} {c}_{p} ( B ) dT + {\int }_{{T}_{o}}^{{T}_{R}} {c}_{p} ( {T}_{i} ) dT + \frac{3}{4} [ {\int }_{{T}_{R}}^{{T}_{F}} {c}_{p} ( {T}_{i} ) dT + {L}_{l} ( {T}_{i} ) + {L}_{v} ( {T}_{i} ) ] + \frac{1}{4} [ {\int }_{{T}_{R}}^{{T}_{F}} {c}_{p} ( {T}_{i} B ) dT + {L}_{l} ( {T}_{i} B ) + {L}_{v} ( {T}_{i} B ) ] \qquad ( 23 )$$

Similar to the model of Ti:B=1:2, several intervals are created based on energy requirements:
E₁=1/4∫_{T}_{ₒ}^{T}^{_{R}}cₚ(B)dT+∫_{T}_{ₒ}^{T}^{_{R}}cₚ(Tᵢ)dT=11.91 kJ/mol: Energy required to trigger the reaction.
E₂=1/4∫_{T}_{ₒ}^{T}^{_{R}}cₚ(B)dT+∫_{T}_{ₒ}^{T}^{_{R}}cₚ(Tᵢ)dT+3/4∫_{T}_{_{R}}^{T}^{_{M}}^{(T}^{ᵢ}⁾cₚ(Tᵢ)dT+1/4∫_{T}_{_{R}}^{T}^{_{M}}^{(T}^{ᵢ}⁾cₚ(TᵢB)dT=50.33 kJ/mol: Energy required to raise the whole system to the melting temperature of Ti, without melting.
E₃=1/4∫_{T}_{ₒ}^{T}^{_{R}}cₚ(B)dT+∫_{T}_{ₒ}^{T}^{_{R}}cₚ(Tᵢ)dT+3/4[∫_{T}_{_{R}}^{T}^{_{M}}^{(T}^{ᵢ}⁾cₚ(Tᵢ)dT+L₁(Tᵢ₎]+1/4∫_{T}_{_{R}}^{T}^{_{M}}^{(T}^{ᵢ}⁾cₚ(TᵢB₂)dT=60394 kJ/mol: Energy required to raise the whole system to the melting temperature of Ti, with the melting of Ti.
E₄=1/4∫_{T}_{ₒ}^{T}^{_{R}}cₚ(B)dT+∫_{T}_{ₒ}^{T}^{_{R}}cₚ(Tᵢ)dT+3/4[∫_{T}_{_{R}}^{T}^{_{M}}^{(T}^{ᵢ}^{B)}cₚ(Tᵢ)dT+L₁(Tᵢ₎]+1/4∫_{T}_{_{R}}^{T}^{_{M}}^{(T}^{ᵢ}^{B)}cₚ(TᵢB)dT=77.73 kJ/mol: Energy required to raise the whole system to the melting temperature of TiB, without the melting of TiB.
The molar ratio is 1:x=4:1:

$$n = {n}_{{T}_{i}} = \frac{π {d}^{2} h {ρ}_{{T}_{i}} {ρ}_{B} ( 1 - ɛ )}{4 ( {ρ}_{B} {M}_{{T}_{i}} + \frac{1}{4} {ρ}_{{T}_{i}} {M}_{B} )} = 9.7 \times {10}^{- 9} mol \qquad ( 24 )$$

First, lines printed by laser were analyzed. Second, parameters that could create one flat surface were optimized. Third, the optimized parameters were used to print multiple layers (parts).

A test series of 4×4 samples with laser powder from 80 W to 170 W, and scanning speed from 3 m/s to 0.9 m/s on the solid substrate was designed to investigate the effect of reaction on the alloy process. Based on the laser parameter,

$$\frac{{E}_{laser \_ absorption}}{n} = \frac{APd / v}{n} = 96.22 kJ \text{/} mol > 11.91 kJ \text{/} mol = {E}_{1}$$

This means that the absorbed laser energy can trigger the reaction between titanium and boron. For the surrounding area where there is no laser energy input:

$$\frac{{E}_{reaction \_ absorption}}{n} = {A}^{′} \vert \frac{1}{4} Δ G ( {T}_{i} B ) \vert = 4 kJ \text{/} mol > 11.91 kJ \text{/} mol = {E}_{1}$$

This indicates that the titanium and boron reaction of the molar ratio of 4:1 under this condition is not self-sustainable. For the laser irradiation zone:

$$\frac{{E}_{system}}{n} = \frac{{E}_{laser \_ absorption} + {E}_{reaction \_ absorption}}{n} = 100.22 \sim 685.56 kJ \text{/} mol > {E}_{3}$$

According to the above, the energy input of the combination of laser irradiation and reaction can totally melt the residual Tᵢ.

The designed width of the line is 200 μm, while the real width of the line is 25% wider (254.4 μm) as is shown in FIG. 12A. High laser energy input (168.39 kJ/mol) combining with the energy obtained from the reaction contribute to this phenomenon. Since the hatch distance of the laser is 100 μm, the laser needs to scan twice to finish the designed line. This is confirmed by the two tracks with opposite arcs. Part of the energy is conducted to the surrounding area and also to the substrate, causing the reactions and melting of the surrounding area and the substrate. The existence of iron and carbon as is show in FIG. 12B proves the melting of substrate (the substrate is made of stainless steel for this experiment). The melting of the powder system due to the high energy input created a relatively flat surface, especially the middle of the line. Because the air in the chamber cannot be totally vacuumized of the AM250 machine, there was still oxygen left with argon. So the processing of the powder was poisoned with the appearance of oxygen (FIG. 12B). The spherical particles shown in FIG. 12A are titanium particles from the surrounding area.

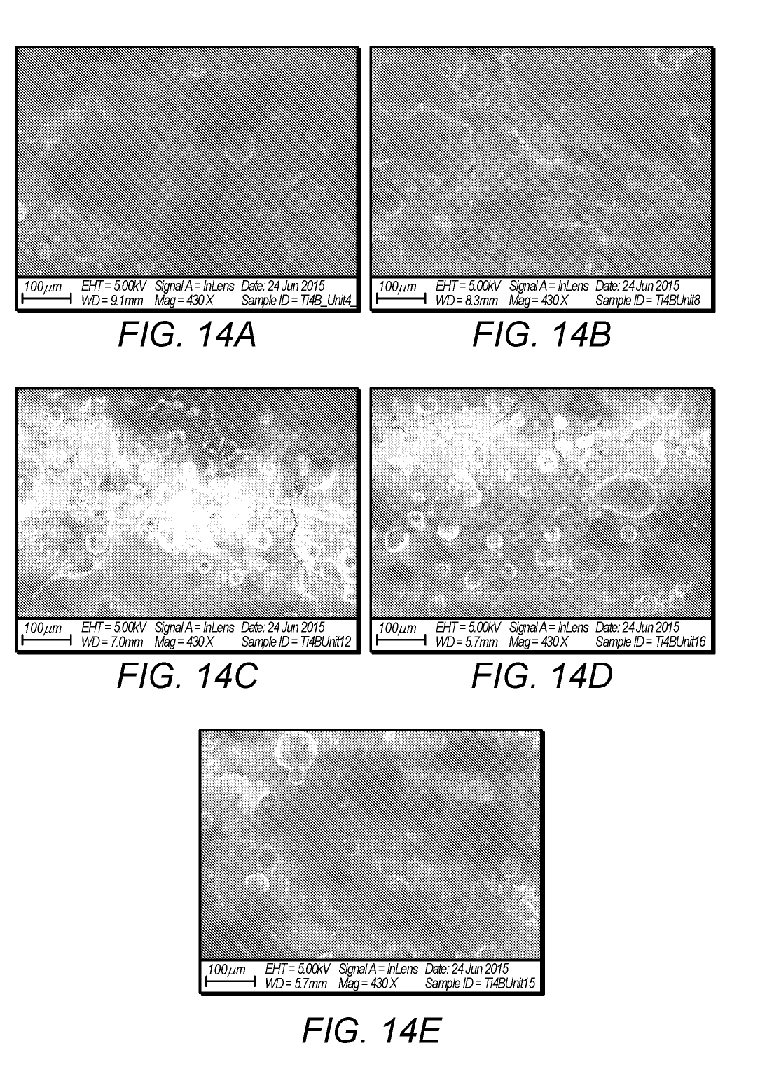

A test series of 4×4 samples with laser powder from 30 W to 120 W, and scanning speed from 5 m/s to 2 m/s on the ceramics was designed as shown in FIG. 13A . The differences between this experiment and the previously described experiments lie in the substrate and shape of the samples. A ceramic substrate was used to avoid the affection of stainless steel. The affection of stainless steel is extremely high especially when only one or just a few layers are printed. The square samples were printed instead of line samples. Since ceramic has a lower heat conductivity than stainless steel, lower laser power was adopted for this experiment.

The energies for each sample, calculated based on the models created before, are shown in Table 3. When the laser power was 30 W, the energies generated could not fully melt the residual Ti (energy required is 60.94 kJ/mol) regardless of the scanning speeds arranging from 5 m/s to 2 m/s. Due to the short of the value of TiB's latent heat of liquefaction, the energy required to fully melt TiB is unknown. However, this energy value should be at least greater than E₄=77.73 kJ/mol, the energy required to raise the whole system to the melting temperature of TiB. Based on the experiment results, the solid complete surface layers can be obtained with the laser power of 120 W, despite of the scanning speed. Thus, it can be concluded that the energy required to fully melt the whole system is between 77.73 kJ/mol and 90.60 kJ/mol. The bold values in Table 3 are the values that satisfy this requirement. And the related sample numbers of these values are: 4, 8, 11, 12, 14, 15, and 16. FIG. 13B shows that the surface of sample 4, 8, 12, 15, and 16 were relatively complete and attached well to the ceramics substrate which are in good agreement with the energies values calculated in Table 3. If the energy values are not high enough to fully melt the powder layer, the printed powder layer will be brittle and cannot even connect well with the surrounding materials, which is the case for the rest of the samples. Afterwards, XRD experiments were conducted on the fabricated samples. FIG. 13C shows the XRD pattern, indicating the unreacted Ti phase and newly generated TiB phase.

TABLE 3

| Scanning Speed | | | | |
|---|---|---|---|---|
| (m/s) | 30 W | 60 W | 90 W | 120 W |
| 5 | 32.02 | 60.11 | 88.20 | 116.29 |
| 4 | 39.04 | 74.15 | 109.26 | 144.38 |
| 3 | 50.74 | 97.56 | 144.38 | 191.19 |
| 2 | 74.15 | 144.38 | 214.60 | 284.83 |

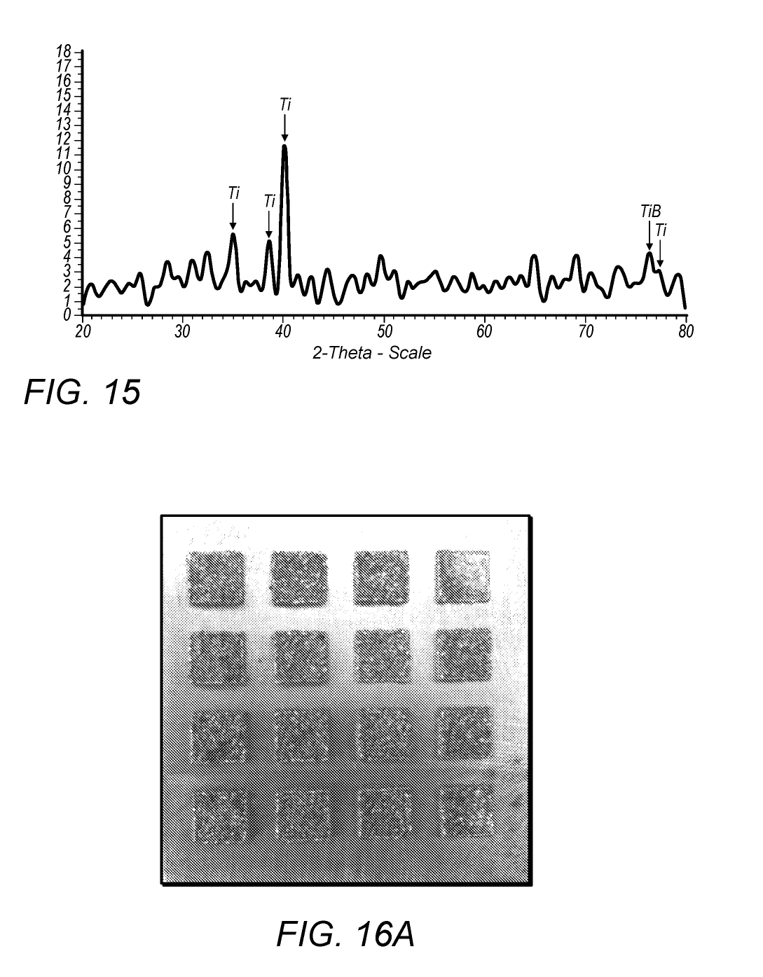

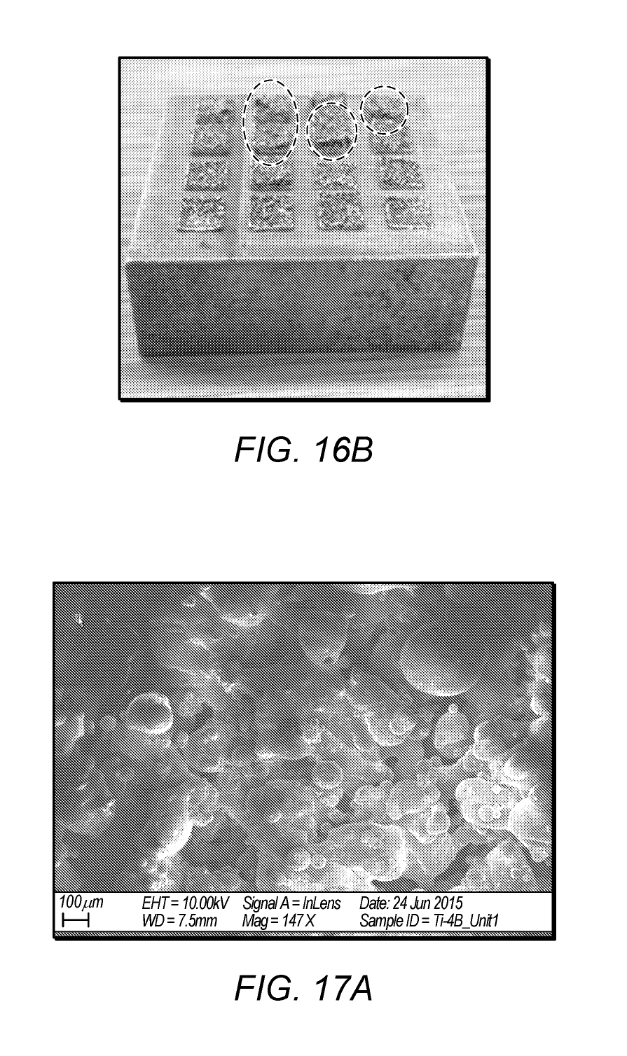

SEM images of the microstructures of sample 4, 8, 12, 16, and 15 are shown in FIG. 14 with the same magnification of 430×. It can be seen that the surfaces are smooth without obvious wrinkles. This indicates that the laser processing parameters are good enough to create high quality of surface finish. However, the appearance of cracks, caused by rapid and uneven cooling and unbalance distribution of the titanium and boron powder of the irradiated area, is a significant defect of building metallic layers on the ceramics substrate. The heat conductivity of ceramics differs a lot from that of metallic material which is the main reason of the uneven cooling. Since the scanning speed is as fast as 2˜5 m/s, some of the titanium particles with large size cannot be fully melted or react with the surrounding boron powder. Thus, titanium particles can still be seen in FIG. 14. According to the analysis, laser power of 120 W is better than any other laser energy inputs of this experiment. In addition, TiB is detected with the scanning speed of 3 m/s under this laser energy input (FIG. 15). Therefore, the laser power parameter of 120 W is selected as the initial setting for the following experiment to build multiple layers with smooth surfaces.

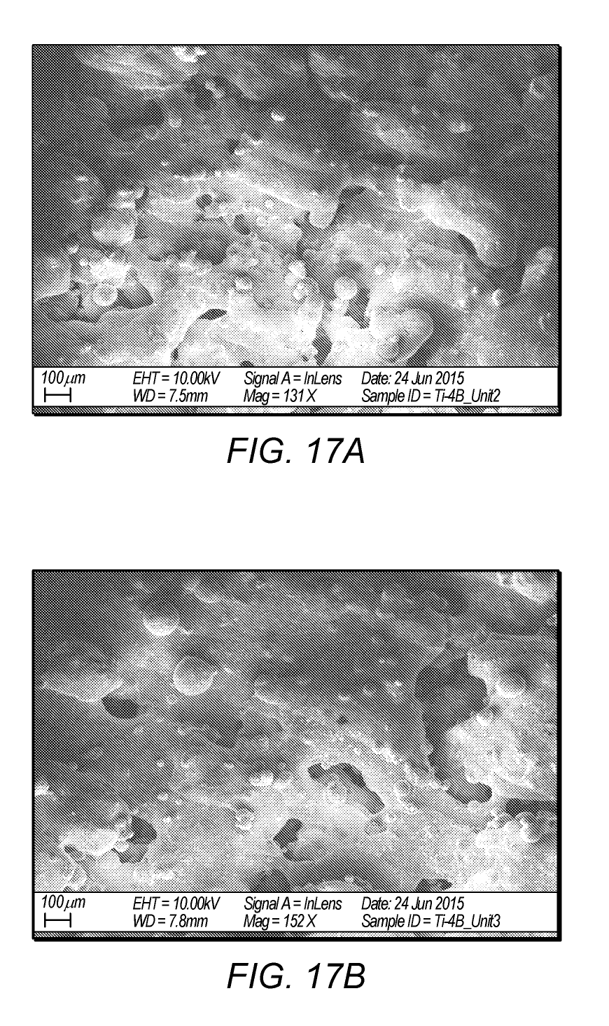

The parameters for the build of multiple layers are listed in Table 4. The bold values shows the initial setting of the laser processing. Due to the limitation of the machine, the powders were manually spread instead of spreading by the wiper mounted inside the chamber of the AM250 machine which resulted in the unequal powder distribution within one layer and different layer thicknesses between multiple layers. These problems can give rise to the uneven surface finish and cracks between two layers. FIG. 16A illustrates the rough surfaces of the printed parts except sample 4 and sample 16. Thus, it can be assumed that solid parts with good surface morphology can be obtained under these laser parameters with proper way of spreading powder. On account of unequal and improper layer thicknesses between different layers, the cracks and gaps between different layers, circled by red-dash lines, are observed in FIG. 16B.

TABLE 4

| Scanning Speed | | | | |
|---|---|---|---|---|
| (m/s) | 80 W | 100 W | 120 W | 140 W |
| 5 | Sample 1 | Sample 2 | Sample 3 | Sample 4 |
| 4 | Sample 5 | Sample 6 | Sample 7 | Sample 8 |
| 3 | Sample 9 | Sample 10 | Sample 11 | Sample 12 |
| 2 | Sample 13 | Sample 14 | Sample 15 | Sample 16 |

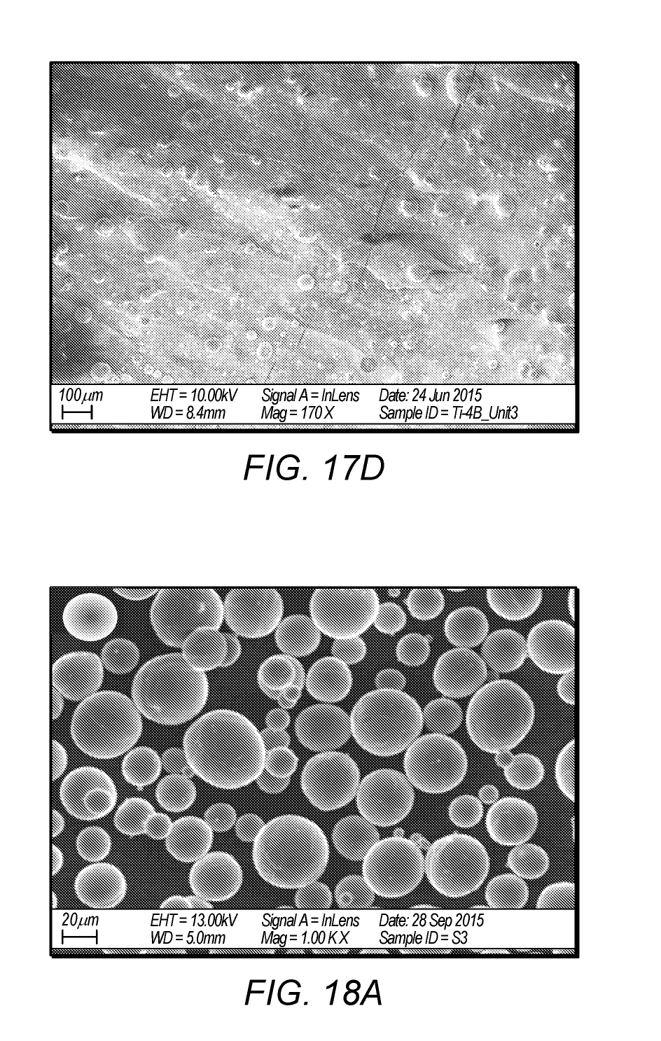

To have a better view of the surface morphology, SEM images of top surface of sample 1, 2, 3, and 4 were taken. FIG. 17A shows the microstructure of the top surface of sample 1. Big gaps between different melted chunks indicate that parameters of sample 1 can only partially melt the powder system with pores inside the solid. At the same time, there is still a great amount of titanium particles left. As for sample 2 (FIG. 17B), the average sizes of the chunks are bigger than that of sample 1 with relatively flat surface. The increasing of laser energy reduces the number of not-melted and unreacted titanium powders as well. When increasing the laser energy from 100 W to 120 W, the printed part is almost fully melted with small and few pores inside which can be seen in FIG. 17C. However, the defects of the existing of pores and titanium particles cannot be avoided. FIG. 17D shows the surface morphology of sample 4 with the highest laser energy of 140 W. It can be noted that there are no pores or big gaps of the top surface. So the laser energy of 140 W is the optimal parameter when the laser scanning speed is 5 m/s. Nevertheless, titanium particles still exist regardless the energy inputs under this scanning speed condition.

### Conclusions

For the molar ratio of 1:2, the reaction was triggered with the parameters: laser power 30 W; scanning speed 7 m/s. Since the reaction was self-sustainable as calculated, burning phenomenon of the irradiation zone and also the surrounding area was observed. The SEM images of the irradiation zone indicated the formation of TiB₂ and also porous structure. This experiment was categorized as low energy input experiment on account of the not-melted TiB₂. To raise the energy input, new parameters were assigned to the samples of test series: laser power 144˜198 W; scanning speed 2-5 m/s. The energy absorbed by the powder system was so high that evaporation occurred to sample 6, 11, and 16 with nothing left at the laser irradiation zone. For the reason that the energy input of sample 1 was relatively lower than any other samples, only part of the material at the laser irradiation zone evaporated. This experiment is categorized as high energy input. It can be seen that all the experiments under this certain molar ratio are in good agreement with the theoretic model developed before. And the model did help for the analysis of the experiment results.

When the molar ratio is 4:1, three different experiments were conducted in the order of line→surface→part. First, lines were printed, the parameters of which provided reference for the surface printing process. However, taking the low heat conductivity of ceramics substrate printing. Smooth surfaces without obvious wrinkles or any other defects were obtained under some certain conditions. And it is proved that high quality of surface finish was achieved with the laser power of 120 W, despite the scanning speed parameter. Thus, for the building of solid parts (multiple layers), the laser power of 120 W was chosen as the initial setting. Because of the limitation of the machine, the mixture powder was manually spread on the substrate, which gave rise to the uneven powder distribution within one layer and uncontrollable layer thicknesses of different layers. These flaws leaded to the rough surface finish and cracks between two layers as was observed of the experiment results. With the increasing of laser power, the defects such as partially melt of the powder system with pores inside the solid part and uneven surface could be weakened or eliminated. Therefore, the laser power of 140 W was the optimal parameter under which solid parts and flat surface were created. Under this laser power condition, the parameter of scanning speed had small effect on the alloying process.

### Additional Experiments

Material and Methods
1. Powder Material

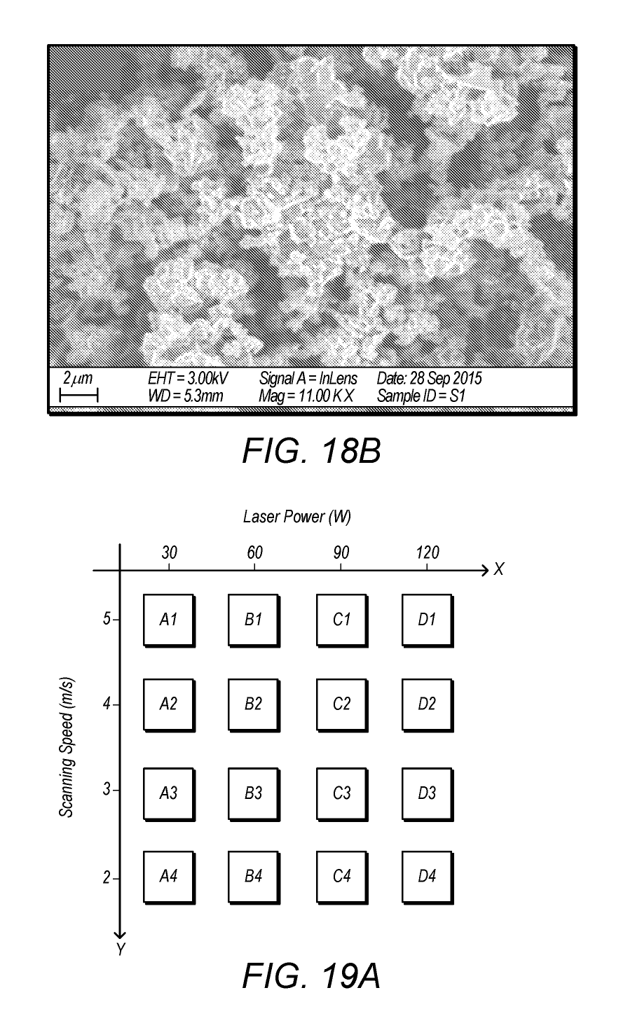

Pure Ti powder supplied by LPW Technology Ltd. (USA) and Pure Boron supplied by the Chemsavers. Inc. (USA) were used in this study. The normal particle size distribution of Ti powder is from 15 to 45 microns and the boron powder's particle size is less than 5 microns. The chemical composition (wt. %) of the pure Ti powder are listed in Table 1. The pure Ti powder had a spherical shape and the pure B powder had an irregular shape, which was shown in FIG. 18A and 18B, respectively.
2. SLA Process

The Selective Laser Alloying was performed on a Renishaw SLM system shown in FIG. 1A. The system uses an Ytterbium fiber laser with a laser power of 200 W adjustable, wavelength of 1070 nm, and a spot size of 70 μm. Other main parts of the system include an automatic powder deposition system, an inert gas protection system, two rectangular platforms with adjustable movement in the Z direction, and a personal computer to control the process. A substrate where the specimens are to be printed, was installed on the building platform. Argon gas with an outlet pressure 30 mbar was filled into the sealed building chamber and the resultant oxygen content decreased below 100 ppm. Meanwhile, the platform can be preheated to a specified temperature (<170° C.). A layer of powder with 50 μm thickness was deposited on the substrate by an automatic powder disposition system. A 2D profile was then formed after scanning with the laser beam according to the CAD data of the specimen.
3. Design of Experiment

Powders with pure Ti to pure B molar ratio of 1:1 were pre-mixed under protective argon atmosphere in a glove box (M. Braun Inertgas Systeme GmbH, MB20). Then, planetary ball mill (Retsch PM 200) with C15 carbon steel balls (10 mm diameter) were used to completely mix the two powders. During the mixing process, the ball-to-powder weight ratio was set to 5:1. In order to avoid alloying or reaction between Ti and B powders during the mixing step, a relatively low rotation speed of 200 rpm for 1˜6 hours was selected for the ball milling process. The machine would rest for 10 seconds in every 5 minutes. In order to optimize the mixture process of powder, a small amount of the mixed powder was taken out for SEM and XRD ever hour.

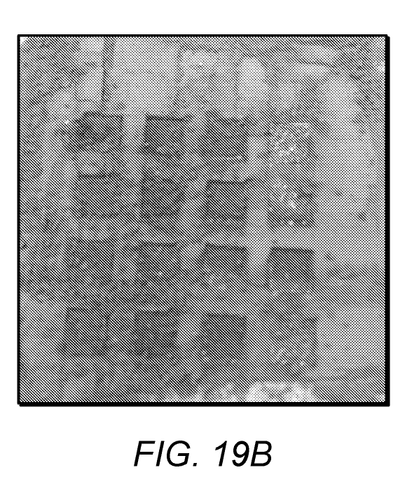

As to the SLA process to be investigated, there are two main parameters that were studied in this research: the laser power and the scanning speed, as they determine the laser energy input. The Renishaw AM 250 allows us to create a sample test series along which different levels of laser power and scanning speed can be assigned when processing each sample in the test series. In this study a 4 by 4 test series composed of 16 specimens with a dimensions of 4mm×4mm is used, as demonstrated in FIG. 19A. Values of the laser power and the scanning speed are assigned along the X and Y direction as demonstrated in the figure. A simple linear raster scan pattern with a scan vector length of 4mm and a hatching spacing of 50 was applied to print the specimens. The specimens were then printed on the stainless steel substrate, which is shown in FIG. 19B.
4. Surface Morphology

The surface morphology was examined by a KEYENCE VHX-500F optical microscope with a digital camera and by a Scanning Electron Microscopy (SEM) (ZEISS Germany) in secondary electron model at 3.00 kV. The SEM enabled the observation of microstructures of the samples with the resolution up to 1 nm, which allow us to observe the surface shape morphology and size distribution of the specimens prepared by SLA. Energy-dispersive X-ray spectroscopy (EDAX), integrated within the SEM machine, can identify and quantify the elements to be observed. Phase characterization identification was performed by X-ray diffraction (XRD) (Bruker D8 Advanced XRD Instrument) with Cu Kα radiation at 40 kV and 40 mA. The wide range of 2θ=20˜80° was carried out to generate a general information of the diffraction peaks, using a continuous scan mode with a slower scan rate of 1° min-1. The XRD experiment results were compare with the existing substances database of XRD. Thus, phase composition can be determined if the experiment diffraction peaks match the corresponding peak positions from the database.

### Results and Discussion

1. Optimal Mill Condition to Mix the Starting Powder

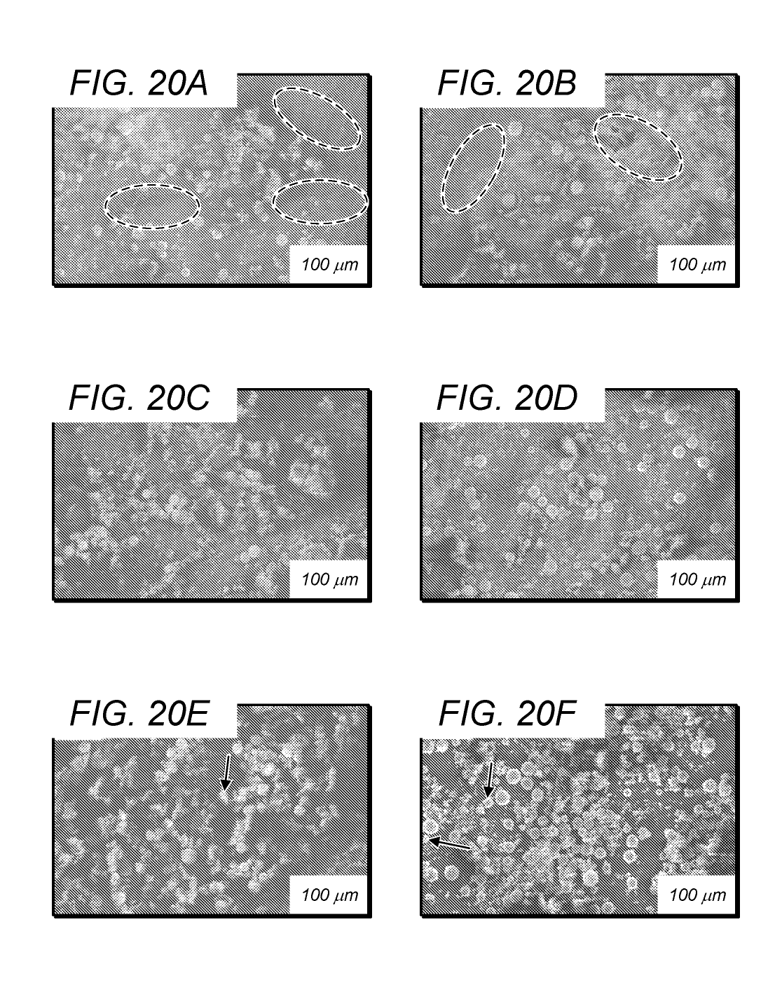

FIGS. 18A and 18B show the particle shape and morphology of the starting powder as-received. As is shown in FIG. 18A, the pure Ti particles exhibit a special morphology and, in FIG. 18B, the pure B has an irregular shape. FIG. 20 compares the resultant morphologies of the Ti/B composite powders after milling. Specifically, FIG. 20 depicts SEM images illustrating the distribution of TUB powders ball-milled for different times:(a) 1 h, (b) 2 h, (c) 3 h, (d) 4 h, (e) 5 h and (f) 6 h. During milling process, because of collisions of balls with the powder, the pure B became fragmented and the Ti powder became flattened. During the first two hour of milling, the titanium particles and the boron particles were not uniformly distributed (FIG. 20A and FIG. 20B). There are very few titanium particles in the blue-dash circled area. In other words, no homogenous dispersion of B particles around Ti powder was obtained. With increasing milling time to 3 h and 4 hours, the titanium particles were well distributed among the boron matrix without obvious “blank area” (FIG. 20C and FIG. 20D). By increasing the milling time up to 5 h and 6 h, the distribution of the titanium particles and the boron particles became more homogeneous (FIG. 20E and FIG. 20F). But a few of broken Ti particles marked by the white arrow were emerged due to the over-milling, which will affect the composite of the specimen.

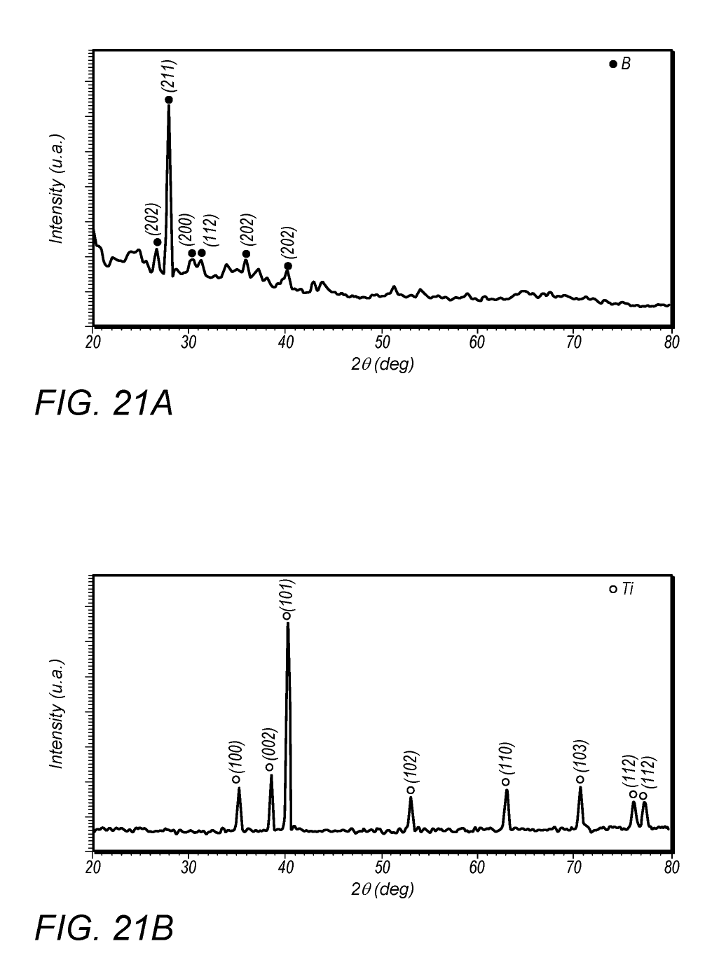

To ensure no reaction occurs during the mixing step, the XRD pattern of TUB mixtures ball-milled for different time duration is provided. Specifically, FIG. 21 depicts XRD patterns of the starting powders (a) B, (b) Ti and (c) Ti/B powder mixture ball-milled for different times. As can be seen from FIG. 21C, no diffraction peaks of TiB or TiB₂ were observed, which means that there are only elemental titanium and boron after the milling. In another word, mechanical mixing, instead of mechanical alloy, of the titanium and boron powders were created.

Therefore, the TUB powder ball-milled for 4 h was selected as the optimal mill condition to prepare the starting powder for SLM because of the uniform distribution of Ti and B powders.
2. Phase Identification

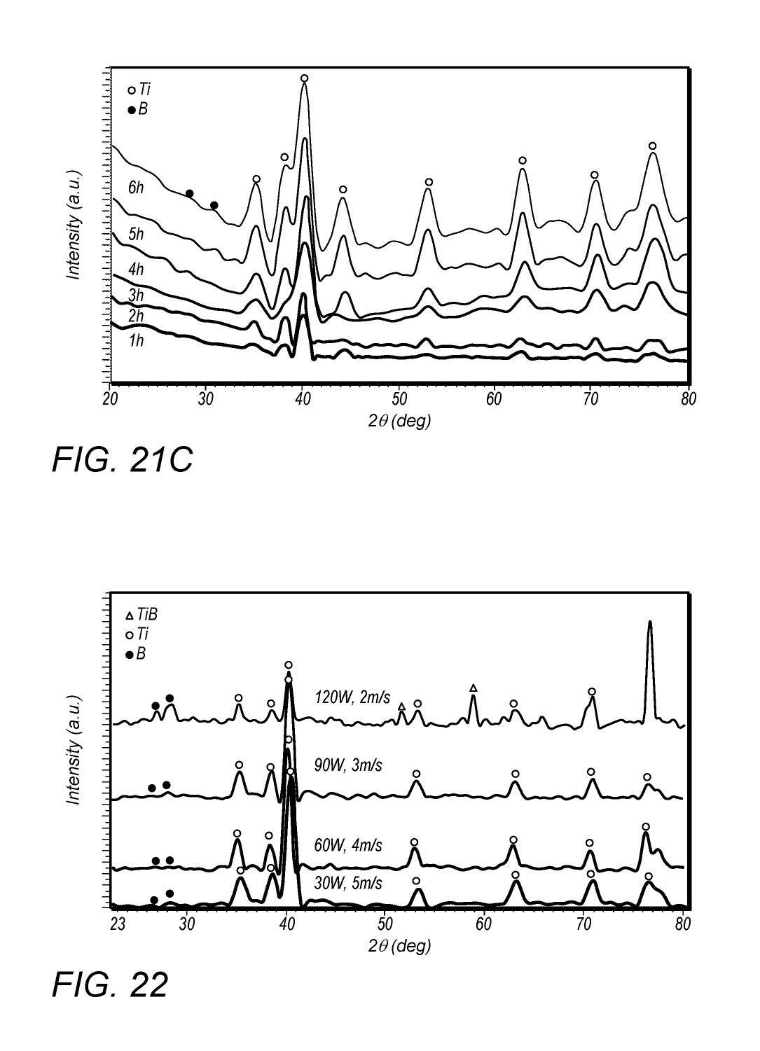

The prepared powder mixture was then deposited to the substrate and selective laser alloyed by the SLM machine to create the test series with specified process conditions. FIG. 22 depicts a comparison of the XRD patterns of the SLM-processed TUB parts using various processing parameters, obtained over a wide range of 2θ. As can be seen from FIG. 21, for specimens created with the following process parameters, (30 W, 5m/s); (60 W, 4m/s); (90 W, 3m/s), the diffraction peaks observed are corresponded to the hexagonal closed-packed Ti and the Rhombohedral Boron, which indicates sufficient laser energy from the beam to trigger the reaction between the Ti and B. For specimens created with laser power of 120 W and scanning speed of 2m/s, the diffraction peaks that matched the TiB were detected, which implied reaction between the Ti and B. In addition, the diffraction peaks matched the Ti and the B are still detected, which revealed that some of the titanium particles with large size cannot be fully melted or react with the surrounding boron powder at this condition.
3. Surface Morphology

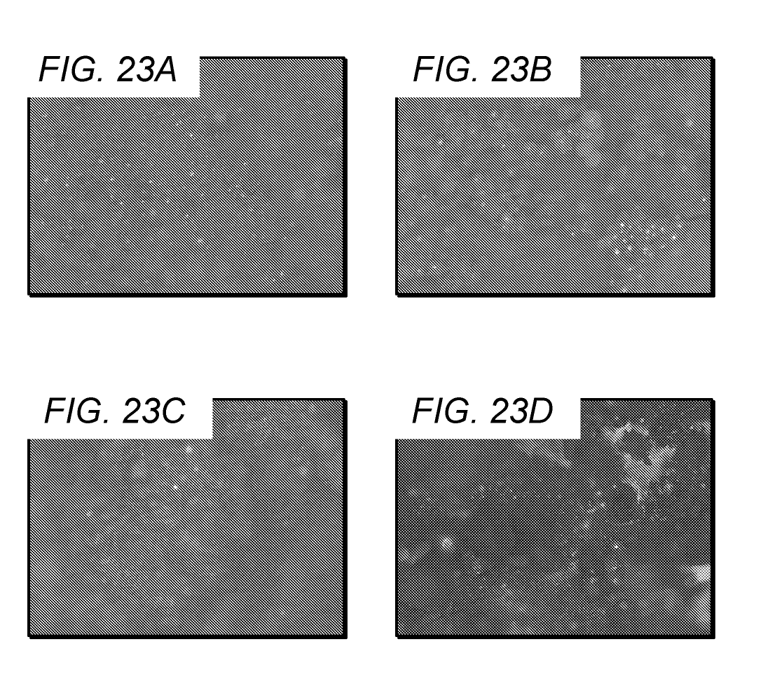

FIG. 23 depicts optical microscope images showing typical surface morphologies of SLM-processed Ti-B parts using various processing parameters: (a) 30 W, 5m/s; (b) 60 W, 4m/s; (c) 90 W, 3m/s; and (d) 120 W, 2m/s. The surface of specimens processed at the laser power of 30 W and the scanning speed of 5m/s were almost the same as the condition of the powder mixture before process (FIG. 23A). This is expected as the combination of laser power and the scanning speed did not produce enough energy to trigger the reaction between the Ti powder and B powder as shown in XRD patterns. With the increasing of the laser power and decreasing of the scanning speed, more energy was applied to the powder mixture, to trigger the reaction between the Ti and B shown in FIG. 23B. When the laser power increased to 90 W and the scanning speed decreased to 3m/s, molten pools were observed, which indicates that the powder of Ti and B were melt in the process. Finally, when the laser power increased to 120 W and the scanning speed decreased to 2m/s, the surface morphologies of the specimen became hard and smooth, which indicates reaction between the powder of Ti and B.

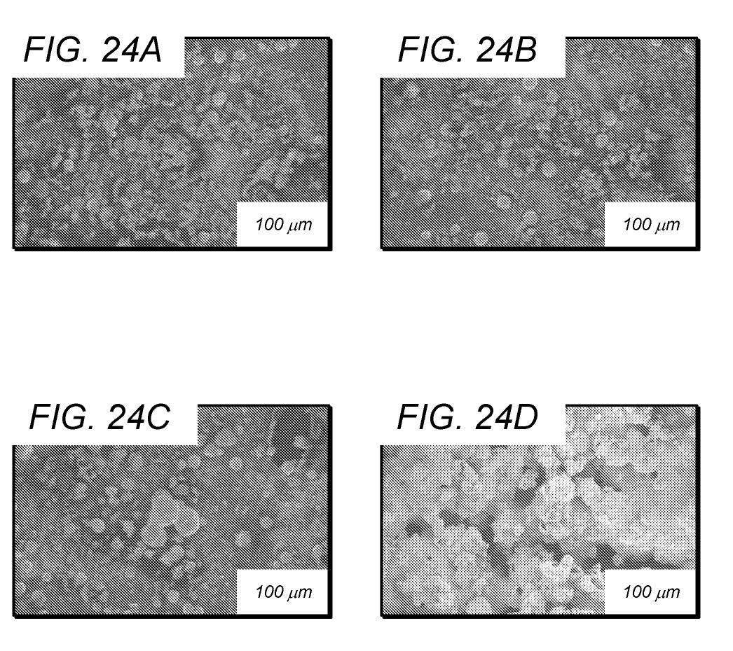

FIG. 24 depicts SEM images showing alloy characteristics of SLM-processed Ti-B parts using various processing parameters: (a) 30 W, 5 m/s; (b) 60 W, 4 m/s; (c) 90 W, 3 m/s; (d) 120 W, 2 m/s.SEM. At a relative high scanning speed of 5 m/s and 4 m/s and a low laser power of 30 W and 60 W, due to the lower energy input, the powders of Ti and B remain the previous status

(FIG. 24A and FIG. 24B), which matches with observation from XRD. As the scanning speed decreased to 3 m/s and the laser power increased to 90 W, certain amount of TiB alloy were formed, implying the occurrence of reaction between the powders (FIG. 24C). At an even lower scanning speed of 2 m/s and the increased laser power of 120 W, we observed solid structure, revealing the complete reaction between the Ti and B powders.
4. Porous Structure at Microscale

Porous structures were observed in the SEM. The size, shape and distribution is highly dependent on the starting powder, plus process parameter, which indicate that porous structure with designable and controllable pore size, shape and distribution can be attained. The concept was based on the discrepant melting point of elemental Titanium and Boron powder and the resulting alloys of the two. The alloying process used in this invention melt the elemental powder above its melting point but below the melting point of the TiBw alloy. This special mechanism creates a boundary between the resulting alloy and the elemental powders, which prevent the additional reaction, which in turn create pores with walls formed by the resulting alloys, around one elemental powder. The shape, size and molar ratio of the elemental powder can be selected to create pores with desired size, shape and distribution. The process can be controlled to attain desired temperature and process rate, so that amount of powder evaporated can be precisely controlled to create the desire wall thickness.
5. Conclusions

Selective laser alloying of elemental metal powder to produce 3D structure was studied following the principles of SLM is investigated. SEM and XRD observations confirmed that the 4 hours of milling is the optimal parameter to completely mix TUB powder before unwanted reaction in the mixing process. XRD investigations revealed that the reaction between the Ti and B occurred when the highest laser power of 120 W and the lowest scanning speed of 2 m/s were used, which produced alloyed TiB. SEM and XRD investigations demonstrated the inherent relation between the processing conditions and surface morphology. Ti and B powders became solid structure and the surface morphologies of the specimen became hard and smooth with the laser power of 120 W and the scanning speed decreased of 2 m/s.

In case porous structures are preferred, the shape, size and molar ratio of the elemental powder can be selected to create pores with desired size, shape and distribution. The process can be controlled to attain desired temperature and process rate, so that amount of powder evaporated can be precisely controlled to create the desire wall thickness. The invented porous material can be used in applications where nano/micro pores are needed. This include coating, lubrication, medical device fabrication, solar panel and energy storage.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method of forming titanium boron alloys comprising:
forming a mixture of elemental titanium with elemental boron; and
heating the mixture with a laser, wherein a power level of the laser is set such that reaction of the elemental titanium with the elemental boron to form a titanium-boron alloy is initiated and self-sustaining.

2. The method of claim 1, wherein forming the mixture comprises milling elemental titanium powder with elemental boron powder.

3. The method of claim 2, wherein the milling process is optimized by selecting a milling time which creates a substantially uniformly distributed mixture.

4. The method of claim 2, wherein the milling process is performed for a time of between about 1 hour and about 3 hours.

5. The method of any one of claims 1-4, wherein the molar ratio of elemental titanium to elemental boron in the mixture is about 1:2.

6. The method of any one of claims 1-4, wherein the molar ratio of elemental titanium to elemental boron in the mixture is about 4:1.

7. The method of any one of claims 1-6, wherein the laser is an ytterbium fiber laser.

8. The method of any one of claims 1-7, wherein the laser is operated at a power of between about 30 W and about 140 W at a scanning speed of between about 2 m/sec to about 7 m/sec.

9. The method of any one of claims 1-8, wherein the mixture is disposed on the surface of a metal object.

10. The method of any one of claims 1-9, wherein the mixture is used in a SLM device to form a 3D object.

11. The method of any one of claims 1-10, wherein the power level of the laser is set such that the newly formed titanium-boron alloy is substantially unmelted during heating of the mixture.

12. A titanium boron alloy made by the method of any one of claims 1-11.

13. The titanium boron alloy of claim 11, wherein the titanium boron alloy has a porosity of up to about 40%.
